(19) United States
(12) Patent Application Publication
(10) Pub. No.: US 2026/0002071 A1
(43) Pub. Date: Jan. 1, 2026

(54) AQUEOUS COMPOSITIONS COMPRISING FUNCTIONALIZED SACCHARIDE POLYMERS FOR DEWATERING OF PARTICULATES

(71) Applicant: INTEGRITY BIO-CHEMICALS, LLC, Cresson, TX (US)

(72) Inventors: Matthew B. BLACKMON, Cresson, TX (US); Stephen W. ALMOND, Creston, CA (US)

(73) Assignee: INTEGRITY BIO-CHEMICALS, LLC, Cresson, TX (US)

(21) Appl. No.: 18/880,767

(22) PCT Filed: Jul. 18, 2023
(86) PCT No.: PCT/US2023/027993

§ 371 Date: Jan. 2, 2025

Related U.S. Application Data
(60) Provisional application No. 63/390,722, filed on Jul. 20, 2022.

(51) Int. Cl. C09K 8/88; C09K 8/60

(52) U.S. Cl. CPC C09K 8/88; C09K 8/604

(57) ABSTRACT

Aqueous compositions comprising an aqueous carrier fluid, a reaction product of a saccharide polymer and a fatty acid or a fatty ester obtained in the aqueous carrier fluid in the presence of a hydroxide base and a neutral surfactant or a reaction product form thereof, a zwitterionic surfactant, and optionally an amine-functionalized saccharide polymer may facilitate dewatering of a plurality of particulates. The reaction product of the saccharide polymer and the fatty acid or the fatty ester, in combination with the neutral surfactant or the reaction product form thereof, and the zwitterionic surfactant may also promote increased aqueous fluid flow through the plurality of particulates. The amine-functionalized saccharide polymer may further increase dewatering of the plurality of particulates and improve clarity of an aqueous filtrate obtained from the plurality of particulates.

### BACKGROUND

Amphiphilic compounds having both hydrophobic and hydrophilic regions within their molecular structure are commonly referred to as “surfactants” or “surfactant compounds.” Surfactants may be found in a wide range of consumer and industrial products including, for example, soaps, detergents, cosmetics, pharmaceuticals, and dispersants. In addition, surfactants are also commonly used in the oil and gas industry, both for upstream and downstream applications. By virtue of their molecular structure, surfactants may promote solubility of an otherwise sparingly soluble substance, increase foaming, facilitate emulsification or de-emulsification, lower viscosity, and/or alter the wetting characteristics of a surface, for instance.

There are difficulties associated with various conventional surfactants. Some common surfactants may be expensive, have poor aqueous solubility, be subject to environmental and/or other government regulations, and/or exhibit incompatibility with other components in an aqueous fluid. Some surfactants may also promote high surface tension values at the critical micelle concentration, which may complicate fluid handling when formulating consumer and industrial products containing such surfactants. A further difficulty associated with conventional surfactants is that the hydrophilic-lipophilic balance (HLB) is fixed by virtue of the molecular structure of a particular amphiphilic compound employed, which is not readily altered without developing an entirely new chemical synthesis for a different chemical entity. If the HLB of a given surfactant is ineffective for a specified application, an otherwise chemically compatible surfactant may be rendered unsuitable for a given set of anticipated use conditions.

Dewatering of sand, slag, and other particulate materials is one application in which surfactants may be used. U.S. Pat. No. 6,797,180, for example, provides an illustrative dewatering procedure in which surfactants may be added to a wet sand slurry to promote enhanced dewatering thereof. Although enhanced dewatering may be realized in the presence of surfactants, the cost and government regulations associated with many conventional surfactants remain a barrier for such dewatering processes. In addition, aqueous fluids containing particulate fines obtained from dewatering processes may be unsuitable for discharge. Such fines-laden aqueous fluids may be obtained in large volumes in the course of dewatering particulates and thus represent significant waste disposal and logistical issues for handling and storage during particulate dewatering processes.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 shows an exemplary reaction sequence for producing an amine-functionalized dextrin compound, specifically an amine-functionalized maltodextrin compound.

FIG. 2 is a graph of flow performance of aqueous compositions through sand particulates (volume of aqueous fluid collected versus time).

### DETAILED DESCRIPTION

The present disclosure generally relates to surfactant technology and, more specifically, aqueous compositions containing surfactant blends that may facilitate enhanced dewatering of particulate materials, such as sand. In non-limiting examples and depending on composition, the aqueous compositions described herein may increase flow rates of aqueous fluids through particulate materials, such as sand; decrease residual moisture content within particulate materials; reduce particulate fines in aqueous fluids removed from particulate materials; or any combination thereof.

As discussed above, conventional surfactants may present various issues such as high cost, poor solubility, high surface tension values, compatibility issues, and/or excessive government regulations, which may limit their suitability for various applications. Moreover, there is no easy way to alter the hydrophobic-lipophilic balance (HLB) of conventional surfactants. These issues may be prevalent to various extents when dewatering particulate materials, such as sand, in the presence of surfactants.

As described in U.S. Patent Application Publication 2021/0340429, aqueous surfactant compositions comprising a reaction product of a fatty acid and a saccharide polymer, such as dextran or a dextrin compound, in combination with a neutral surfactant (co-surfactant), such as various fatty acid amide surfactants, are a versatile class of bio-sourced surfactants. Because they are obtained from materials that are naturally sourced in most cases, such surfactants may be especially desirable when environmental or government regulations may preclude the use of other types of surfactants. Not only is the hydrophilic-lipophilic balance readily alterable by varying the identity and amount of the fatty acid, but surprisingly low surface tension values may be realized when the reaction product is present in combination with the neutral surfactant by virtue of a synergistic interaction between the two. Specifically, when the reaction product of the fatty acid and the saccharide polymer is present in combination with a suitable neutral surfactant, the surface tension may be lower than that of the neutral surfactant by itself at substantially the same concentration in an aqueous fluid. Fatty esters may be reacted to form the reaction products under similar conditions in the presence of a suitable neutral surfactant.

As used herein, the term “fatty acid” refers to a linear, optionally unsaturated, fatty acid containing 4 or more carbon atoms. As used herein, the term “fatty ester” refers to a compound containing one or more ester moieties, which comprises an alcohol component and a fatty acid component. The alcohol component may be a monohydric alcohol or a polyhydric alcohol, such as a diol or triol (e.g., glycerol). The fatty acid component may comprise one or more fatty acids that are saturated or unsaturated, examples of which are provided hereinbelow. Accordingly, the reaction products and aqueous compositions described herein may be free of or substantially free (e.g., less than 5 wt % or less than 1 wt %) of branched fatty acids or products formed therefrom, according to various embodiments. Thus, in various embodiments, the reaction products and aqueous compositions described herein may include one or more fatty acids or products formed therefrom that consist of one or more straight chain fatty acids, which may be saturated or unsaturated.

The reaction products formed from a saccharide polymer and described in further detail herein may be present in combination with a zwitterionic (amphoteric) surfactant to afford additional surprising effects and beneficial advantages. Namely, the compositions described in brief above (i.e., an aqueous surfactant composition comprising a reaction product of a saccharide polymer in combination with a neutral surfactant or a reaction product form thereof, such as a fatty acid alkanolamide) may be present in combination with a zwitterionic surfactant to promote increased flow rates of aqueous fluids through particulate materials, such as sand. In addition, decreased residual moisture content within dewatered particulate materials may be realized in some instances. The increased flow rates and decreased residual moisture may be measured relative to amounts obtained when contacting a plurality of particulates with water alone.

The foregoing blends of zwitterionic surfactants and aqueous surfactant compositions may be present in further combination with amine-functionalized saccharide polymers to afford still further advantages and surprising benefits when accomplishing the foregoing. Suitable amine-functionalized saccharide polymers may comprise dextran polymers (dextrans) or dextrin compounds in which a plurality of glucose units have been oxidatively opened and functionalized with at least one amine group at a site of oxidative opening. The amine-functionalized saccharide polymers are known to promote clay stabilization during subterranean treatment operations, as described in U.S. Pat. Nos. 10,072,208, 10,351,770, 11,028,314, and 11,130,905, each of which is incorporated herein by reference. Surprisingly, such amine-functionalized saccharide polymers may provide additional advantageous and surprising benefits when dewatering particulate materials, even those that are not necessarily clay-based. For example, the amine-functionalized saccharide polymers may aid in lowering residual moisture within dewatered particulate materials while still maintaining rapid aqueous fluid flow rates therethrough. In addition to decreasing residual moisture content following dewatering of particulate materials, the clarity of the aqueous fluid (filtrate) recovered following particulate dewatering may be significantly improved when the amine-functionalized saccharide polymers are present during dewatering. Without being bound by theory or mechanism, the improved aqueous fluid clarity is believed to arise from decreased fines retention in the aqueous fluid when the amine-functionalized saccharide polymers are present.

Accordingly, in some embodiments, aqueous compositions of the present disclosure may comprise an aqueous carrier fluid; a neutral surfactant or a reaction product form thereof; a reaction product of a first saccharide polymer comprising a dextran, a dextrin compound, or any combination thereof, and the reaction product of the first saccharide polymer and the fatty acid or the fatty ester and the reaction product form of the neutral surfactant, if present, being formed in the presence of a hydroxide base in the aqueous carrier fluid; and a zwitterionic surfactant. Optionally, an amine-functionalized saccharide polymer may be present as a further component in the aqueous compositions in some cases. Accordingly, in some embodiments, aqueous compositions of the present disclosure may comprise an aqueous carrier fluid; a neutral surfactant or a reaction product form thereof; a reaction product of a first saccharide polymer comprising a dextran, a dextrin compound, or any combination thereof, and the reaction product of the first saccharide polymer and the fatty acid or the fatty ester and the reaction product form of the neutral surfactant, if present, being formed in the presence of a hydroxide base in the aqueous carrier fluid; a zwitterionic surfactant; and an amine-functionalized saccharide polymer, the amine-functionalized saccharide polymer being formed from a second saccharide polymer comprising a plurality of glucose units in which at least a portion of the glucose units have been oxidatively opened and functionalized with at least one amine group at a site of oxidative opening. The first saccharide polymer and/or the second saccharide polymer (if present) may comprise a dextran, a dextrin, or any combination thereof in any embodiment herein. The first saccharide polymer and the second saccharide polymer may be the same or different. Additional description of the foregoing components in the aqueous compositions of the present disclosure are provided further below.

Suitable aqueous carrier fluids for use in the disclosure herein may include, for example, fresh water, acidified water, seawater, brine (i.e., a saturated salt solution), or an aqueous salt solution (i.e., a non-saturated salt solution). Water-miscible organic co-solvents such as ethanol or ethylene glycol, for example, may be present in combination with an aqueous carrier fluid, in some embodiments. The aqueous carrier fluids may disperse the various components in an emulsion form and/or in a dissolved (solution) form. In more specific embodiments herein, each of the components within the aqueous compositions may be present in a dissolved form over the range of concentrations utilized.

Without being limited by theory, the reaction products produced from the first saccharide polymer and a fatty acid or a fatty ester may include at least one fatty ester saccharide polymer reaction product formed from a reaction between the first saccharide polymer (e.g., a dextran or a dextrin compound) and the fatty acid or the fatty acid component of the fatty ester, which may then interact synergistically with a neutral surfactant or other components of the aqueous compositions in accordance with the description above. Specifically, in addition to the synergism exhibited with the neutral surfactant to afford low surface tension values, the reaction products may exhibit further synergism and provide beneficial effects in combination with a zwitterionic surfactant and/or an amine-functionalized saccharide polymer to promote enhanced dewatering of particulate materials, such as sand.

To form a fatty ester saccharide polymer reaction product from a fatty ester starting material, the fatty ester may undergo initial hydrolysis under alkaline conditions to generate a fatty acid component or a salt form thereof, which may then react with the first saccharide polymer to form at least one fatty ester saccharide polymer reaction product. Alternately, the fatty ester may undergo direct transesterification with the first saccharide polymer to form at least one fatty ester saccharide polymer reaction product. When used, free fatty acids or a salt form thereof, in contrast, may react directly with the first saccharide polymer to form the fatty ester saccharide polymer reaction products described herein. Any one or more than one of the primary or secondary alcohol functionalities upon the glucose monomer units of the first saccharide polymer may undergo a reaction to form a fatty ester saccharide polymer reaction product suitable for use in the disclosure herein.

In the course of forming a fatty ester saccharide polymer reaction product from a fatty ester, such as an animal or vegetable oil, the alcohol component of the fatty ester may be released into the aqueous carrier fluid in which the fatty ester saccharide polymer reaction product is being formed. The alcohol component may remain present with the fatty ester saccharide polymer reaction product in the aqueous carrier fluid or undergo at least partial removal therefrom. Advantageously and surprisingly, the alcohol component released into the aqueous carrier fluid does not significantly impact the low surface tension values attainable when the fatty ester saccharide polymer reaction product and the neutral co-surfactant are present together. The alcohol component (e.g., glycerol) released into the aqueous carrier fluid may further aid in solubilizing or dispersing other components of the aqueous composition. Optionally, additional glycerol may be blended with the aqueous compositions, including aqueous compositions made from free fatty acids or compositions made from other types of fatty esters in which glycerol is not present. Other water-miscible alcohols may be included as a co-solvent as well.

Illustrative fatty acids (or fatty acid components within fatty esters) that may be suitable for forming a reaction product of the present disclosure include, for example, butyric acid, valeric acid, caproic acid, enanthic acid, caprylic acid, pelabonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, trioscylic acid, lignoceric acid, pentacosylic acid, cerotic acid, carboceric acid, montanic acid, nonacosylic acid, melissic acid, crotonic acid, cervonic acid, linoleic acid, linolelaidic acid, linolenic acid, arachidonic acid, docosatetraenoic acid, myristoleic acid, palmitoleic acid, sappenic acid, vaccenic acid, paullinic acid, oleic acid, pinolenic acid, stearidonic acid, eleostearic acid, elaidic acid, gondoic acid, gadoleic acid, erucic acid, eicosenoic acid, eicosadiencoic acid, eicosatrienoic acid, eicosatetraenoic acid, docosadienoic acid, nervonic acid, mead acid, adrenic acid, the like, and any combination thereof. Any of these fatty acids may be present in the aqueous compositions specified herein. Particular fatty acids and amounts thereof that are reacted with the first saccharide polymer may be selected to adjust the hydrophobic-lipophilic balance for a specified application, for instance.

Fatty esters have at least one alcohol component and at least one fatty acid component (one or more of the fatty acids mentioned above) that may be liberated under the alkaline conditions (from a hydroxide base) in the aqueous carrier fluid and subsequently form a reaction product with the first saccharide polymer. Suitable fatty esters for forming reaction products with the first saccharide polymer are not believed to be particularly limited, provided that the fatty esters undergo effective hydrolysis (or transesterification) to release an alcohol component and one or more fatty acid components of the fatty ester to promote formation of a reaction product with the first saccharide polymer. Fatty acids originating from the fatty esters and suitable for forming reaction products of the first saccharide polymer may be selected (through selection of a suitable fatty ester containing one or more desired fatty acids) to afford saccharide polymer reaction products having a range of HLB values, such as HLB values of about 5 to about 20. Illustrative types of fatty esters are provided below. The fatty acids originating from the fatty esters may range in size from about C₄ to about C₃₀, or about C₄ to about C₂₀, or about C₆ to about C₁₈, or about C₈ to about C₂₄, any one or more of which may be saturated or unsaturated. When the saccharide polymer reaction products are formed from a fatty ester sourced from plant or animal oils, at least one unsaturated fatty acid, such as oleic, linoleic or linolenic acid, may be present in the saccharide polymer reaction product.

In some embodiments, the fatty ester used to form the saccharide polymer reaction products, such as a fatty ester saccharide polymer reaction product, may comprise a glycerol ester. A glycerol ester may undergo alkaline hydrolysis to liberate glycerol as an alcohol component, and up to three fatty acid components per glycerol alcohol component may be released for undergoing a reaction with the first saccharide polymer according to the disclosure herein. The fatty acid components released from the glycerol ester may be the same or different, and/or at least one unsaturated fatty acid may be among the fatty acid components. Accordingly, when a saccharide polymer reaction product is formed from a glycerol fatty ester, the aqueous compositions described herein may further contain glycerol. Alternately, glycerol may be added to the aqueous compositions as an additional component even when a glycerol ester is not used for forming the saccharide polymer reaction products.

Glycerol esters suitable for forming a saccharide polymer reaction product for use in the aqueous compositions described herein are not believed to be particularly limited and may comprise any plant oil, animal oil, plant fat, animal fat, or any combination thereof that contains one or more desired fatty acids. The glycerol ester may undergo hydrolysis or transesterification in the course of forming a reaction product of the first saccharide polymer. Suitable glycerol esters may be found in plant or animal sources including, for example, soybean oil, grapeseed oil, olive oil, palm oil, rice bran oil, safflower oil, corn oil, coconut oil, sunflower seed oil, canola oil, rapeseed oil, peanut oil, cottonseed oil, hazelnut oil, tea seed oil, linseed oil, sesame oil, acai oil, almond oil, beech nut oil, brazil nut oil, cashew oil, macadamia nut oil, pecan oil, pine nut oil, pistachio oil, walnut oil, pumpkin seed oil, apricot oil, avocado oil, grapefruit oil, lemon oil, orange oil, mango oil, flax seed oil, fish oil, cocoa butter, hemp oil, castor oil, tall oil, fish oil, cattle fat, buffalo fat, sheep fat, goat fat, duck fat, pig fat, poultry fat, and any combination thereof.

Soybean oil, for example, contains a mixture of saturated and unsaturated fatty acids, predominantly palmitic acid, stearic acid, oleic acid, linoleic acid, and linolenic acid, with the monounsaturated and polyunsaturated fatty acids (oleic acid, linoleic and linolenic acids) comprising a majority of the fatty acids obtainable from the soybean oil. Palm oil contains about 50% saturated fatty acids (palmitic acid, stearic acid, and myristic acid) and 50% unsaturated fatty acids (oleic acid, linoleic acid, and linolenic acid). Coconut oil contains predominantly saturated fatty acids (caprylic acid, capric acid, lauric acid, myristic acid, palmitic acid, and stearic acid) and less than 10% unsaturated fatty acids (oleic acid and linoleic acid). These mixtures of fatty acids represent particular examples of fatty acid blends that may be present in the saccharide polymer reaction products of the aqueous compositions described herein. It is to be appreciated that the reaction products of the present disclosure are not limited to the foregoing blends of fatty acids, however.

When glycerol esters are used as a direct (in situ) source of fatty acids for formation of saccharide polymer reaction products, glycerol may be present in the aqueous compositions. Optionally, the glycerol may be at least partially or fully removed from the aqueous compositions, if desired. Otherwise, the amount of glycerol present in the aqueous compositions may be dictated by the amount of glycerol ester that is present when forming the reaction product. For example, for glycerol esters containing C₈-C₂₄ fatty acids, the weight percentage of glycerol in the glycerol esters may range from about 7 wt. % to about 17 wt. %, based on total mass of the glycerol ester. Accordingly, the corresponding weight percentages of glycerol in aqueous compositions containing the saccharide polymer reaction product, as measured relative to the fatty acid(s) originating from the glycerol upon alkaline hydrolysis, may range from about 7.5 wt. % to about 20 wt. %. Alternately, the weight percentage of glycerol in the aqueous compositions may be substantially equivalent on a mass basis, with respect to the entirety of the aqueous composition, to the weight percentage of glycerol ester in a reaction mixture from which the saccharide polymer reaction product is formed, since each glycerol ester may release one glycerol molecule upon undergoing complete hydrolysis. Again, it is to be appreciated that additional glycerol may be added to the aqueous compositions or at least some glycerol may be removed from the aqueous compositions in response to particular application requirements.

In addition or as an alternative to glycerol, one or more additional alcohols may be present in the aqueous compositions described herein, preferably one or more alcohols having at least partial water miscibility. In non-limiting examples, the one or more additional alcohols may comprise one or more C₁-C₁₂, or C₁-C₈, or C₁-C₄ monohydric or dihydric alcohols. Non-limiting examples of suitable alcohols may include, but are not limited to, methanol, ethanol, 1-propanol, isopropanol, 1-butanol, 2-butanol, t-butanol, 1-pentanol, 2-pentanol, 3-pentanol, 2-methyl-1-butanol, 2-methyl-2-butanol, cyclopentanol, cyclohexanol, ethylene glycol, propylene glycol, and the like. When present, the one or more additional alcohols may be present at about 10 wt. % or less, or about 5 wt. % or less, or about 2 wt. % or less with respect to the entire mass of the aqueous composition.

Suitable hydroxide bases for forming the saccharide polymer reaction products may include, for example, alkali metal hydroxides, such as sodium hydroxide, potassium hydroxide, or any combination thereof. A stoichiometric excess or a stoichiometric deficit of the hydroxide base relative to an amount of the fatty ester or fatty acid may be present. Therefore, the aqueous compositions may comprise one or more fatty ester dextrins and/or one or more fatty ester dextrans, optionally in further combination with a fatty acid salt (e.g., an alkali metal carboxylate), and/or a hydroxide base (e.g., an alkali metal hydroxide base). When using a fatty ester to form a saccharide polymer reaction product, the hydroxide base may be present in at least a sufficient molar quantity to react with at least a portion of the fatty ester to promote hydrolysis thereof and to convert the fatty acid component of the fatty ester into a fatty acid salt (e.g., an alkali metal carboxylate) for reaction with the first saccharide polymer. Alternately, the hydroxide base may be present in a sufficient amount to form a fatty acid salt (e.g., an alkali metal carboxylate) when forming the saccharide polymer reaction products directly from a free fatty acid. If still present after forming a saccharide polymer reaction product, excess hydroxide base may be neutralized with an acid or be at least partially removed through washing.

A molar ratio of fatty acid or fatty acid originating from a fatty ester to glucose monomers in the first saccharide polymer of the saccharide polymer reaction products may be about 0.05 or above on a basis of moles_{fatty acid or fatty acid in fatty ester}:moles_{glucose monomers in first saccharide polymer}, or about 0.08 or above on a basis of moles_{fatty acid or fatty acid in fatty ester}:moles_{glucose monomers in first saccharide polymer}, or about 0.1 or above on a basis of moles_{fatty acid or fatty acid in fatty ester}:moles_{glucose monomers in first saccharide polymer}, or about 0.2 or above on a basis of moles_{fatty acid or fatty acid in fatty ester}:moles_{glucose monomers in first saccharide polymer}, or about 0.3 or above on a basis of moles_{fatty acid or fatty acid in fatty ester}:moles_{glucose monomers in first saccharide polymer}, or about 0.4 or above on a basis of moles_{fatty acid or fatty acid in fatty ester}:moles_{glucose monomers in first saccharide polymer}, or about 0.5 or above on a basis of moles_{fatty acid or fatty acid in fatty ester}:moles_{glucose monomers in first saccharide polymer}, or about 0.6 or above on a basis of moles_{fatty acid or fatty acid in fatty ester}:moles_{glucose monomers in first saccharide polymer}, or about 0.7 or above on a basis of moles_{fatty acid or fatty acid in fatty ester}:moles_{glucose monomers in first saccharide polymer}, or about 0.8 or above on a basis of moles_{fatty acid or fatty acid in fatty ester}:moles_{glucose monomers in first saccharide polymer}, or about 0.9 or above on a basis of moles_{fatty acid or fatty acid in fatty ester}:moles_{glucose monomers in first saccharide polymer}. A maximum ratio of fatty acid to the first saccharide polymer (e.g., a dextrin compound or dextran) in the saccharide polymer reaction product, based upon glucose monomers, may be about 1.0 in most cases, although molar ratios above 1.0 also reside within the scope of the present disclosure. Thus, in some embodiments, the molar ratio of fatty acid to glucose monomers in the saccharide polymer reaction product may range from about 0.05 moles_{fatty acid or fatty acid in fatty ester}:moles_{glucose monomers in first saccharide polymer} to about 1.0 moles_{fatty acid or fatty acid in fatty ester}:moles_{glucose monomers in first saccharide polymer}, or about 0.05 moles_{fatty acid or fatty acid in fatty ester}:moles_{glucose monomers in first saccharide polymer} to about 0.9 moles_{fatty acid or fatty acid in fatty ester}:moles_{glucose monomers in first saccharide polymer}, or about 0.05 moles_{fatty acid or fatty acid in fatty ester}:moles_{glucose monomers in first saccharide polymer} to about 0.8 moles_{fatty acid or fatty acid in fatty ester}:moles_{glucose monomers in first saccharide polymer}, or about 0.05 moles_{fatty acid or fatty acid in fatty ester}:moles_{glucose monomers in first saccharide polymer} to about 0.7 moles_{fatty acid or fatty acid in fatty ester}:moles_{glucose monomers in first saccharide polymer}, or about 0.05 moles_{fatty acid or fatty acid in fatty ester}:moles_{glucose monomers in first saccharide polymer} to about 0.6 moles_{fatty acid or fatty acid in fatty ester}:moles_{glucose monomers in first saccharide polymer}, or about 0.05 moles_{fatty acid or fatty acid in fatty ester}:moles_{glucose monomers in first saccharide polymer} to about 0.5 moles_{fatty acid or fatty acid in fatty ester}:moles_{glucose monomers in first saccharide polymer}, or about 0.05 moles_{fatty acid or fatty acid in fatty ester}:moles_{glucose monomers in first saccharide polymer} to about 0.4 moles_{fatty acid or fatty acid in fatty ester}:moles_{glucose monomers in first saccharide polymer}, or about 0.1 moles_{fatty acid or fatty acid in fatty ester}:moles_{glucose monomers in first saccharide polymer} to about 0.9 moles_{fatty acid or fatty acid in fatty ester}:moles_{glucose monomers in first saccharide polymer}, or about 0.1 moles_{fatty acid or fatty acid in fatty ester}:moles_{glucose monomers in first saccharide polymer} to about 0.8 moles_{fatty acid or fatty acid in fatty ester}:moles_{glucose monomers in first saccharide polymer}, or about 0.1 moles_{fatty acid or fatty acid in fatty ester}:moles_{glucose monomers in first saccharide polymer} to about 0.7 moles_{fatty acid or fatty acid in fatty ester}:moles_{glucose monomers in first saccharide polymer}, or about 0.1 moles_{fatty acid or fatty acid in fatty ester}:moles_{glucose monomers in first saccharide polymer} to about 0.6 moles_{fatty acid or fatty acid in fatty ester}:moles_{glucose monomers in first saccharide polymer}, or about 0.1 moles_{fatty acid or fatty acid in fatty ester}:moles_{glucose monomers in first saccharide polymer} to about 0.5 moles_{fatty acid or fatty acid in fatty ester}:moles_{glucose monomers in first saccharide polymer}, or about 0.1 moles_{fatty acid or fatty acid in fatty ester}:moles_{glucose monomers in first saccharide polymer} to about 0.4 moles_{fatty acid or fatty acid in fatty ester}:moles_{glucose monomers in first saccharide polymer}, or about 0.2 moles_{fatty acid or fatty acid in fatty ester}:moles_{glucose monomers in first saccharide polymer} to about 0.9 moles_{fatty acid or fatty acid in fatty ester}:moles_{glucose monomers in first saccharide polymer}, or about 0.2 moles_{fatty acid or fatty acid in fatty ester}:moles_{glucose monomers in first saccharide polymer} to about 0.8 moles_{fatty acid or fatty acid in fatty ester}:moles_{glucose monomers in first saccharide polymer}, or about 0.2 moles_{fatty acid or fatty acid in fatty ester}:moles_{glucose monomers in first saccharide polymer} to about 0.7 moles_{fatty acid or fatty acid in fatty ester}:moles_{glucose monomers in first saccharide polymer}, or about 0.2 moles_{fatty acid or fatty acid in fatty ester}:moles_{glucose monomers in first saccharide polymer} to about 0.6 moles_{fatty acid or fatty acid in fatty ester}:moles_{glucose monomers in first saccharide polymer}, or about 0.2 moles_{fatty acid or fatty acid in fatty ester}:moles_{glucose monomers in first saccharide polymer} to about 0.5 moles_{fatty acid or fatty acid in fatty ester}:moles_{glucose monomers in first saccharide polymer}, or about 0.2 moles_{fatty acid or fatty acid in fatty ester}:moles_{glucose monomers in first saccharide polymer} to about 0.4 moles_{fatty acid or fatty acid in fatty ester}:moles_{glucose monomers in first saccharide polymer}, or about 0.3 moles_{fatty acid or fatty acid in fatty ester}:moles_{glucose monomers in first saccharide polymer} to about 0.9 moles_{fatty acid or fatty acid in fatty ester}:moles_{glucose monomers in first saccharide polymer}, or about 0.3 moles_{fatty acid or fatty acid in fatty ester}:moles_{glucose monomers in first saccharide polymer} to about 0.8 moles_{fatty acid or fatty acid in fatty ester}:moles_{glucose monomers in first saccharide polymer}, or about 0.3 moles_{fatty acid or fatty acid in fatty ester}:moles_{glucose monomers in first saccharide polymer} to about 0.7 moles_{fatty acid or fatty acid in fatty ester}:moles_{glucose monomers in first saccharide polymer}, or about 0.3 moles_{fatty acid or fatty acid in fatty ester}:moles_{glucose monomers in first saccharide polymer} to about 0.6 moles_{fatty acid or fatty acid in fatty ester}:moles_{glucose monomers in first saccharide polymer}, or about 0.3 moles_{fatty acid or fatty acid in fatty ester}:moles_{glucose monomers in first saccharide polymer} to about 0.5 moles_{fatty acid or fatty acid in fatty ester}:moles_{glucose monomers in first saccharide polymer}, or about 0.3 moles_{fatty acid or fatty acid in fatty ester}:moles_{glucose monomers in first saccharide polymer} to about 0.4 moles_{fatty acid or fatty acid in fatty ester}:moles_{glucose monomers in first saccharide polymer}, or about 0.4 moles_{fatty acid or fatty acid in fatty ester}:moles_{glucose monomers in first saccharide polymer} to about 0.9 moles_{fatty acid or fatty acid in fatty ester}:moles_{glucose monomers in first saccharide polymer}, or about 0.4 moles_{fatty acid or fatty acid in fatty ester}:moles_{glucose monomers in first saccharide polymer} to about 0.8 moles_{fatty acid or fatty acid in fatty ester}:moles_{glucose monomers in first saccharide polymer}, or about 0.4 moles_{fatty acid or fatty acid in fatty ester}:moles_{glucose monomers in first saccharide polymer} to about 0.7 moles_{fatty acid or fatty acid in fatty ester}:moles_{glucose monomers in first saccharide polymer}, or about 0.4 moles_{fatty acid or fatty acid in fatty ester}:moles_{glucose monomers in first saccharide polymer} to about 0.6 moles_{fatty acid or fatty acid in fatty ester}:moles_{glucose monomers in first saccharide polymer}, or about 0.4 moles_{fatty acid or fatty acid in fatty ester}:moles_{glucose monomers in first saccharide polymer} to about 0.5 moles_{fatty acid or fatty acid in fatty ester}:moles_{glucose monomers in first saccharide polymer}. The foregoing ratios may represent a molar ratio of fatty acid (or molar ratio of fatty acids within a fatty ester) reacted with the dextran or dextrin compound comprising the first saccharide polymer. One or more hydroxyl groups per glucose monomer may undergo a reaction in some cases, particularly at a molar ratio of about 1.0 or above. At least a portion of the glucose monomers may remain unfunctionalized, particularly at lower molar ratios. Unreacted fatty acids, if any, may remain in the aqueous compositions as a fatty acid salt of the hydroxide base.

In various embodiments, suitable examples of the first saccharide polymer that may form a reaction product in the disclosure herein may include a dextrin compound, a dextran, or any combination thereof. Other examples of first saccharide polymers that may be utilized to form the reaction products in the aqueous compositions of the present disclosure may include, but are not limited to, glycogen, guar, xanthan, welan, scleroglucan, chitosan, schizophyllan, levan, pectins, inulin, arabinoxylans, pullulan, gellan, carrageenan, chitosan, chitin, cellulose, starch, or any combination thereof. Saccharide polymer fragments obtained from any of the foregoing and containing about 3 to about 25 monomers per fragment may also be utilized for forming the reaction products used in the aqueous compositions as well. Although the following description is largely directed to dextrin compounds and dextrans, and how such first saccharide polymers may form a reaction product with a fatty acid or fatty ester, it is to be appreciated that the foregoing saccharide polymers may afford alternative reaction products in a similar manner that may also be suitable for use in the disclosure herein.

Maltodextrins are one type of suitable dextrin compound that may be utilized to form a saccharide polymer reaction product in the disclosure herein. Maltodextrins may be advantageous due to their low cost, environmentally benign nature, and the relative ease with which they may be chemically reacted with various free fatty acids or fatty acids originating from a fatty ester, such as a glycerol ester. Depending on the fatty acid(s) reacted with a maltodextrin, the hydrophobic-lipophilic balance (HLB) of the reaction products may range from about 5 to about 20 or more, wherein known molecular contributions may be utilized to calculate the HLB value. In addition to property variation resulting from the fatty acid size and amount thereof, maltodextrins are available in a range of oligomer sizes (e.g., 3-20 glucose monomers, or even up to about 25 glucose monomers), which may allow further property tailoring to be realized. Thus, maltodextrin reaction products may be adapted for use under a wide range of conditions anticipated to be present in a given application. Reaction products formed from dextrans may offer similar advantages and features to those afforded by maltodextrin reaction products.

Maltodextrins and other dextrin compounds suitable for use as the first saccharide polymer in the present disclosure may comprise 2 to about 20 glucose monomers, or even up to about 25 glucose monomers, linked together with α(1,4) glycosidic bonds. At least a portion of the glucose monomers may form a reaction product upon being contacted under suitable conditions with a fatty acid or a fatty ester, including fatty acid salts obtained therefrom, such as a salt of a C₄-C₃₀ fatty acid or a C₄-C₂₀ fatty acid. Without being limited by theory, at least a portion of the glucose monomers in the dextrin compound may react to form a fatty ester dextrin reaction product, which may be optionally present in combination with unreacted fatty acid salt in the aqueous compositions described herein. When formed, a fatty ester dextrin reaction product may form at any hydroxyl group of the dextrin compound, including any combination of primary and/or secondary hydroxyl groups. Hydroxyl groups upon the neutral surfactant may undergo a similar esterification reaction under the same reaction conditions within the aqueous carrier fluid.

Dextran is a saccharide polymer characterized by predominantly α(1,6) glycosidic bonds between adjacent glucose monomers, with a limited number of glucose side chains linked to the main polymer backbone via α(1,3) glycosidic bonds. The α(1,3) glycosidic bonds may introduce crosslinks between adjacent saccharide polymer chains. Depending on the biological source, the extent of branching and the molecular weight of dextran may vary considerably, any of which may be utilized in the disclosure herein. At least a portion of the glucose monomers in dextran may form a reaction product upon being contacted under suitable conditions with a fatty acid or a fatty ester, including a fatty acid salt obtained therefrom, such as a salt of a C₄-C₃₀ fatty acid or a C₄-C₂₀ fatty acid. Without being limited by theory, at least a portion of the glucose monomers may react with a fatty acid or fatty ester to form a fatty ester dextran in some embodiments, which may be optionally present in combination with unreacted fatty acid salt in the aqueous compositions. When formed, a fatty ester reaction product may form at any hydroxyl group of the dextran.

In some embodiments, the saccharide polymer reaction products in the aqueous compositions of the present disclosure may be formed from a dextrin compound having 3 to about 20 glucose monomers, or even up to about 25 glucose monomers, that are covalently linked by α(1,4) glycosidic bonds. Formula 1 below shows the generic structure of a dextrin compound having only α(1,4) glycosidic bonds between adjacent glucose monomers, wherein variable ‘a’ is a positive integer ranging from 1 to about 18, thereby providing a dextrin backbone with 3 to about 20 glucose monomers. In the case of a dextrin compound containing up to 25 glucose monomers, variable ‘a’ may range from 1 up to about 23. The terminal glucose unit is shown in its closed form in Formula 1, but may also be present in the corresponding reducing sugar (open chain or acyclic) form as well.

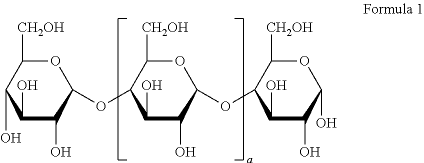

Other dextrin compounds may contain only α(1,6) glycosidic bonds or a mixture of α(1,4) and α(1,6) glycosidic bonds, and such dextrin compounds may also be suitable for use in forming saccharide polymer reaction products within the aqueous compositions. The numbering of a single glucose monomer is shown in Formula 2 below. Particularly suitable dextrin compounds may have a molecular weight (e.g., Mₙ) in the range of about 1200 to about 1400 or about 1100 to about 1500.

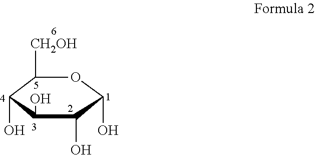

In some or other embodiments, the saccharide polymer reaction products may be formed from a first saccharide polymer that includes a dextran obtained from any suitable source. The structure of dextran is shown in Formula 3 below, in which the α(1,3) glycosidic bonds are not shown in the interest of clarity. Where they occur, the α(1,3) glycosidic bonds may append a terminal glucose monomer as a side chain to the α(1,6)-linked saccharide polymer backbone, form crosslinks between adjacent α(1,6)-linked saccharide polymer backbones, interrupt the α(1,6)-linked saccharide polymer backbone with an α(1,3) glycosidic bond, or any combination thereof. Depending on source, up to about 5% of the glucose monomers may be linked by α(1,3) glycosidic bonds. Linkage by α(1,3) glycosidic bonds may occur upon any of the glucose monomers.

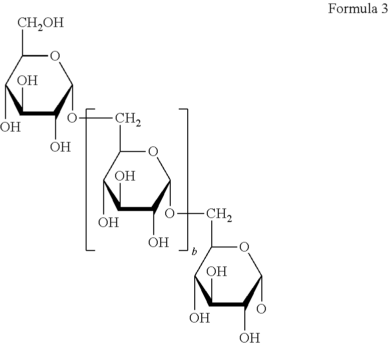

Suitable dextrans may have a molecular weight of about 1200, or about 1400, or about 5000 up to about 50,000,000, or about 100,000 up to about 20,000,000. As such, variable ‘b’ may range from about 30 to about 300,000 depending on the particular dextran selected. Particularly suitable dextrans may have a molecular weight (e.g., Mₙ) ranging from about 1200 to about 1400, or about 1100 to about 1500, or about 1000 to about 100,000, or about 100,000 to about 1 million, or about 2 million to about 5 million, or about 5 million to about 50 million. Another suitable dextran may have a molecular weight of about 500,000 and an activity level of about 9%.

As indicated above, maltodextrins may comprise the first saccharide polymer when forming a reaction product within the aqueous compositions described herein. Maltodextrins may be characterized in terms of their dextrose equivalent (DE) value. Dextrose equivalent is a measure of the amount of reducing sugars (e.g., glucose monomers) that are present in a saccharide polymer, particularly a dextrin, expressed as a percentage relative to dextrose. Starch, which is functionally non-reducing, has a defined dextrose equivalent of 0, whereas dextrose itself has a dextrose equivalent of 100. Dextrose equivalent may be calculated by dividing the molecular weight of glucose by Mₙ and multiplying the result by 100. Higher dextrose equivalent values are characteristic of a lower number of covalently linked glucose monomers (shorter polymer backbone length, thereby providing a higher relative percentage of terminal reducing sugars). Maltodextrins suitable for forming a saccharide polymer reaction product with one or more fatty acids or fatty esters may exhibit dextrose equivalent values ranging from 3 to about 25 or from 3 to about 20. In more specific embodiments, dextrose equivalent values of the maltodextrins may range from about 4.5 to about 7.0, or from about 7.0 to about 10.0, or from about 9.0 to about 12.0.

Maltodextrins suitable for forming a saccharide polymer reaction product may be obtained from hydrolysis or pyrolysis of starch, specifically the amylose component of starch, according to some embodiments. A maltodextrin having Formula 1 may be formed by hydrolysis or pyrolysis of amylose, for example. Alternative suitable dextrin compounds may be obtained from hydrolysis or pyrolysis of the amylopectin component of starch, in which case the dextrin compound may contain α(1,6) glycosidic bonds if the dextrin compound is obtained through hydrolysis of the amylopectin side chain. Starches from which the dextrin compounds are subsequently produced may be obtained from any starch source.

Thus, the saccharide polymer reaction products and associated aqueous compositions described herein may be advantageous due to their substantial biological origin, low cost and ability to afford low surface tension values when present in combination with a suitable neutral surfactant as a co-surfactant. Reaction products of maltodextrin, for example, may represent a particularly useful class of dextrin-based reaction products due to the low cost and convenient molecular weight range of this first saccharide polymer. Various fatty acids having a range of molecular weights may be used to produce saccharide polymer reaction products having a range of HLB values. Moreover, a number of fats, oils and similar glycerol esters may serve as convenient and inexpensive sources for a fatty ester or fatty acids obtained therefrom, examples of which are provided above, used in forming the saccharide polymer reaction products described herein. Likewise, fats, oils, similar glycerol esters, and other fatty esters, and amounts thereof may be selected to promote tailoring of the surfactant properties, such as altering HLB values and/or varying performance during particulate dewatering, for instance.

In some embodiments and preferably, the saccharide polymer reaction product may be formed in the presence of a neutral surfactant whose surface tension may be lowered in the presence of the saccharide polymer reaction product. Preferably, the neutral surfactant may comprise a fatty acid alkanolamide neutral surfactant. Thus, the saccharide polymer reaction products may be present in the aqueous carrier fluid at a concentration effective to lower the surface tension of the neutral surfactant compared to that of the neutral surfactant alone at a substantially similar concentration in the aqueous carrier fluid.

At the same time, the neutral surfactant or a reaction product form thereof may be present in the aqueous carrier fluid at a concentration effective to solubilize the saccharide polymer (first saccharide polymer) prior to forming the reaction product and the saccharide polymer reaction product itself after a reaction has taken place. That is, the neutral surfactant may facilitate formation of aqueous compositions that are aqueous solutions of the saccharide polymer reaction product. In non-limiting examples, the neutral surfactant may be present in the aqueous carrier fluid at a concentration of about 20 wt. % or less, or about 10 wt. % or less, or about 5 wt. % or less, such as about 1 wt. % to about 10 wt. %, or about 3 wt. % to about 8 wt. %, each based on total mass of the aqueous composition.

Suitable neutral surfactants may comprise one or more fatty acid alkanolamide surfactants. Fatty acid alkanolamide surfactants which may have their surface tension lowered in combination with a saccharide polymer reaction product include cocamide-based surfactants, such as cocamide diethanolamine, cocamide monoethanolamine, cocamide monoisopropanolamine, cocamide diisopropanolamine, and the like. Cocamide diethanolamine (CocoDEA) or cocamide diisopropanolamine (CocoDIPA) may be particularly suitable neutral surfactants for use in the disclosure herein. Other fatty acid amide alkanolamines (alkanolamides), such as palmitic acid amide diethanolamine, palmitic acid monoethanolamine, or palmitic acid diisopropanolamine may also be suitable for use in the disclosure herein.

Zwitterionic surfactants (also known as amphoteric surfactants) may also be present in the aqueous compositions to afford synergistic behavior in combination with the saccharide polymer reaction product and the neutral surfactant. For example, the combination of a saccharide polymer reaction product, a suitable neutral surfactant, and a suitable zwitterionic surfactant may promote an increased rate of aqueous fluid flow through a particulate material, such as sand, as measured relative to water alone. In addition, the combination of a saccharide polymer reaction product, a suitable neutral surfactant, and a suitable zwitterionic surfactant may decrease moisture retention in a particulate material, such as sand, as measured relative to water alone. In some embodiments, suitable zwitterionic surfactants for inclusion in the aqueous compositions may include, for example, betaines, sultaines, amine oxides, or any combination thereof. Particular examples of suitable zwitterionic surfactants may include, for example, cocamidopropylbetaine, alkanoyl hydroxysultaines (e.g., lauryl hydroxysultaine), cocamidopropyl hydroxysultaine, alkanamidopropyl hydroxysultaines (e.g., lauramidopropyl hydroxysultaine), sodium cocoamphohydroxypropylsulfonate, amphodiacetates, and the like.

The zwitterionic surfactant may be present the aqueous compositions over a range of concentrations. In non-limiting examples, one or more zwitterionic surfactants may be present in the aqueous compositions at a concentration of about 25 wt. % or less, or about 20 wt. % or less, or about 15 wt. % or less, or about 10 wt. % or less, or about 5 wt. % or less, or about 2.5 wt. % or less, or about 1 wt. % or less, or about 0.5 wt. % or less, or about 0.4 wt. % or less, or about 0.3 wt. % or less, or about 0.2 wt. % or less, or about 0.1 wt. % or less, or about 0.09 wt. % or less, or about 0.08 wt. % or less, or about 0.07 wt. % or less, or about 0.06 wt. % or less, or about 0.05 wt. % or less, or about 0.04 wt. % or less, or about 0.03 wt. % or less, or about 0.02 wt. % or less, or about 0.01 wt. % or less, each based on total mass of the aqueous compositions, and provided that the amount of zwitterionic surfactant is non-zero.

Once formed, the pH of aqueous compositions described herein may reside within a range of about 1 to about 14, such as a range of about 1 to about 5, or about 5 to about 7, or about 7 to about 9, or about 9 to about 14. The pH may be raised or lowered, if needed, after forming the saccharide polymer reaction products in accordance with the disclosure herein. Adjustment of the pH may also alter the protonation state of the amine-functionalized saccharide polymer, when present. Lower surface tension values may be realized as the pH decreases in some instances. Decreased surface tension values may also be realized in the presence of a dissolved salt within the aqueous carrier fluid, such as potassium chloride.

Saccharide polymer reaction products, which may include those formed through a reaction of one or more fatty acids or one or more fatty esters with a dextrin compound and/or a dextran, may be prepared by a process comprising: heating a saccharide polymer comprising a dextran, a dextrin compound (e.g., comprising 3 to about 20 glucose monomers, or even up to about 25 glucose monomers, linked together with α(1,4) glycosidic bonds, such as maltodextrin), or any combination thereof, a fatty acid or a fatty ester, a neutral surfactant (e.g., a fatty acid alkanolamide) and a hydroxide base in an aqueous carrier fluid, and obtaining a reaction product of the saccharide polymer and the fatty acid or fatty ester in the aqueous carrier fluid. The aqueous carrier fluid may further contain glycerol, which may originate from a fatty ester used to form the reaction products and/or additional glycerol may be added separately to the reaction products. The reaction product may be present in the aqueous carrier fluid at a concentration effective to lower a surface tension of the neutral surfactant, as measured relative to the neutral surfactant alone at a like concentration in the aqueous carrier fluid. For example, a 5 wt. % solution of the neutral surfactant in water may have a higher surface tension than does an aqueous composition containing 5 wt. % of the neutral surfactant in combination with a saccharide polymer reaction product that is present in a surface tension-lowering amount. Heating may be conducted at a temperature of about 100° C. or less, such as at about 50° C. to about 80° C., or about 60° C. to about 70° C., or about 50° C. to about 60° C.

Surface tension values for the aqueous compositions of the present disclosure may be about 40 dynes/cm or less, or about 38 dynes/cm or less, or about 36 dynes/cm or less, or about 34 dynes/cm or less, or about 32 dynes/cm or less, or about 30 dynes/cm or less, or about 28 dynes/cm or less. Alternately, the surface tension values may be lowered up to about 40% relative to the surface tension of the neutral surfactant in the aqueous carrier fluid alone at a like concentration, or lowered up to about 30%, or lowered up to about 20%, or lowered up to about 15%, or lowered up to about 10%. For instance, the surface tension values may be lowered in an amount of about 10% to about 25%, or about 10% to about 20%, or about 15% to about 25%, as measured relative to the surface tension of the neutral surfactant in the aqueous carrier fluid alone at a substantially identical concentration to that in an aqueous composition containing a saccharide polymer reaction product.

Amine-functionalized saccharide polymers may be prepared separately from the saccharide polymer reaction products described above (e.g., fatty ester saccharide polymer reaction products) before being combined therewith. The amine-functionalized saccharide polymers may be formed from a second saccharide polymer, which may be the same as or different than the first saccharide polymer. Any of the saccharide polymers (first saccharide polymer) described above as being suitable for forming the saccharide polymer reaction product may be used similarly as a source material for the second saccharide polymer being used to produce the amine-functionalized saccharide polymer in the disclosure herein. As with the saccharide polymer reaction products discussed above, amine-functionalized saccharide polymers may similarly be advantageous due to the low cost of the corresponding unfunctionalized (parent) saccharide polymers, the ease with which the corresponding parent saccharide polymers may be functionalized, and the environmentally benign nature of both the parent saccharide polymers and their amine-functionalized forms.

Amine-functionalized saccharide polymers, such as amine-functionalized dextrin compounds, may be produced through oxidative opening of a portion of the glucose units in a parent saccharide polymer (e.g., a dextrin compound), followed by reductive amination of at least a portion of the resulting aldehyde functionalities. The corresponding amine-functionalized dextrans may be prepared in a similar manner. Additional description of the amine-functionalized saccharide polymers, such as amine-functionalized dextrin compounds and amine-functionalized dextrans, and suitable functionalization methods is provided hereinbelow.

In some examples, suitable amine-functionalized dextrin compounds for use in the disclosure herein may comprise amine-functionalized maltodextrin compounds, which are prepared by partial oxidation and reductive amination of a maltodextrin parent compound. Maltodextrin parent compounds having a range of oligomer sizes (e.g., 3-20 glucose monomers, or even up to about 25 glucose monomers) may allow some tailoring of the properties obtained therefrom through choice of the dextrin backbone chain length and the amine functionalization occurring thereon according to the present disclosure. Amine-functionalized dextrans may be produced in a like manner to that used for producing amine-functionalized dextrin compounds, such as amine-functionalized maltodextrin.

Suitable amine-functionalized dextrin compounds may be prepared from a second saccharide polymer that is a dextrin compound by a process comprising: providing a dextrin compound comprising 3 to about 20 glucose units linked together with α(1,4) glycosidic bonds, reacting the dextrin compound with a periodate compound to oxidatively open a portion of the glucose units to form a dialdehyde intermediate, and reacting an amine compound with the dialdehyde intermediate under reductive amination conditions to covalently bond at least one amine group at one or more sites of oxidative opening, the amine compound comprising a primary amine group or a secondary amine group. After completing the reductive amination reaction, at least one secondary amine group or tertiary amine group is covalently bound to the site of oxidative opening (i.e., at a carbon atom that was previously an aldehyde group). Any aldehyde groups that do not undergo imine formation are instead reduced to a primary alcohol under the reductive amination conditions. Any of the maltodextrins described hereinabove may represent a suitable dextrin parent compound for undergoing functionalization through sequential oxidation and reductive amination according to the disclosure herein. Alternative amine-functionalized dextrins having α(1,6) glycosidic bonds may be formed through a similar process from a suitable dextrin parent compound.

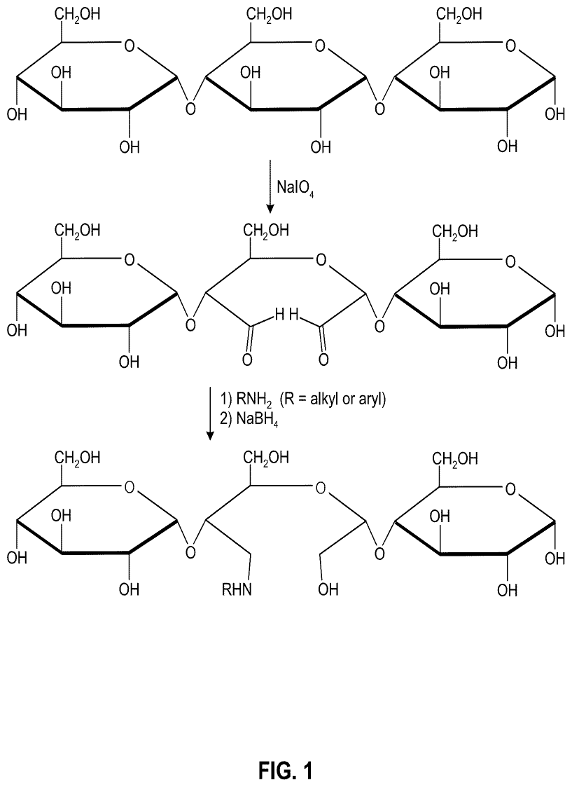

FIG. 1 shows an exemplary reaction sequence for producing an amine-functionalized dextrin compound, specifically an amine-functionalized maltodextrin compound. In the interest of clarity, only a single glucose unit is shown to undergo functionalization according to FIG. 1, but it is to be appreciated that any number and arrangement of the glucose units may undergo oxidative opening and reductive amination in a manner consistent with the present disclosure. Moreover, the depicted number of glucose units in FIG. 1 is illustrative and non-limiting. Although FIG. 1 shows the introduction of a single amine group at the site of oxidative opening, it is to be recognized that both carbon atoms at the site of oxidative opening may undergo functionalization in some instances. Moreover, some of the sites of oxidative opening may fail to undergo functionalization with an amine group in some cases, in which case two primary alcohol groups may be present following reduction. Other amine-functionalized dextrin compounds may be formed in a similar manner using a suitable dextrin and a suitable primary or secondary amine.

Likewise, amine-functionalized dextrans suitable for use in the disclosure herein may also be functionalized using a similar procedure to that depicted in FIG. 1. In the interest of brevity, the like functionalization of dextran with an amine is not discussed in further detail herein.

As shown in FIG. 1, a portion of the glucose units in the parent dextrin compound (alternately, the parent dextran) may undergo oxidative ring opening in the presence of a periodate compound to form a dialdehyde intermediate derived from a glucose monomer unit. The glycosidic bonds in the parent dextrin compound are preserved following oxidative ring opening in this manner. The periodate compound may be sodium periodate in more specific embodiments of the present disclosure. In still more specific embodiments, the periodate compound may be reacted with the parent dextrin compound in water at a temperature ranging from about −10° C. to about 25° C. Alternately, a mixture of water and a water-miscible organic solvent may be used, provided that the water-miscible organic solvent is non-reactive toward periodate. Similar synthetic details apply to oxidizing dextran for subsequent amine functionalization.

After forming the dialdehyde intermediate, a primary amine or a secondary amine may be reacted with at least one of the aldehyde groups to form an imine intermediate (intermediate not shown in FIG. 1). Typically, the imine intermediate is not isolated, but is instead reacted in situ with a reducing agent to form a secondary amine group or a tertiary amine group that is directly covalently bound to the dextrin compound at the site of oxidative opening (i.e., at one of the former aldehyde carbon atoms at a given site of oxidative opening). One or both of the aldehyde groups at a given site of oxidative opening may undergo imine formation and subsequent reduction. Any aldehyde groups not undergoing imine formation (including sites of oxidative opening that have not reacted with an amine at all) and subsequent reduction to form a covalently bonded amine are instead reduced to a primary alcohol group at the site of oxidative opening. Thus, in some embodiments, the amine-functionalized dextrin compounds, particularly the amine-functionalized maltodextrin compounds, may bear a primary alcohol (on a first carbon atom) and a secondary amine or a tertiary amine (on a second carbon atom) at a site of oxidative opening upon the dextrin backbone. Optionally, at least some of the sites of oxidative opening may remain unfunctionalized with an amine and instead contain two primary alcohol groups. Alternately, the amine-functionalized dextrin compounds may bear a secondary amine or a tertiary amine on both carbon atoms at the site of oxidative opening. Dextrans may be oxidized and functionalized with an amine in a similar manner.

In more specific embodiments, the reducing agent for conducting the reductive amination may be sodium borohydride or like mild reducing agents. The solvent for imine formation and subsequent reduction may be water or a mixture of water and an alcohol, for example, and the reactions may take place at a temperature from about −10° C. to about 25° C. Similar synthetic details apply to functionalizing a dextran via reductive amination. Other suitable conditions for performing reductive amination will be familiar to persons having ordinary skill in the art.

As mentioned above, suitable amines for undergoing a reaction with the dialdehyde intermediate are primary amines or secondary amines. Primary amines lead to the formation of a secondary amine following reductive amination, and secondary amines lead to formation of a tertiary amine following reductive amination. Suitable amines may otherwise exhibit a variety of structures, and may be selected from entities including primary monoamines, secondary monoamines, diamines, triamines and other polyamines, amino alcohols, amino acids, and the like. Particularly suitable amines may include, but are not limited to, methylamine, dimethylamine, methylethylamine, ethylamine, diethylamine, propylamine, butylamine, hexylamine, octylamine, ethylenediamine, propylenediamine, diethylenetriamine, triethylenetetraamine, ethanolamine, 2-aminopropanol, 1-amino-2-propanol, diethanolamine, and the like. When more than one amine group is present in the amine, such as in a diamine like ethylenediamine, a first amine group of the diamine may be directly covalently bound to a carbon atom at a given site of oxidative opening, and a second amine group of the diamine may be unbonded to a carbon atom at the site of oxidative opening. That is, the second amine group is not directly covalently bonded to the site of oxidative opening and is instead tethered with a carbon-containing spacer group to the first amine group. The second amine group may be further functionalized, if desired. Alternately, the second amine group also may promote at least some degree of crosslinking in some instances, wherein the second amine group may be covalently bonded to a different site of oxidative opening. Such crosslinking may be intermolecular (between different saccharide polymer chains) or intramolecular (within the same saccharide polymer chain).

In more particular embodiments, suitable amine-functionalized maltodextrin compounds within the aqueous compositions of the present disclosure may have a structure defined by Formulas 4-6 below, in which one covalently bonded amine group is shown at each site of oxidative opening. It is to be appreciated that two covalently bonded amine groups may be present in some embodiments (structures not shown), as discussed above. Moreover, it is to be appreciated that not every site of oxidative opening necessarily becomes amine-functionalized and/or not every glucose monomer unit undergoes oxidative opening, as likewise discussed above. Any combination of the terminal glucose units (rings A and C in Formulas 4-6) and non-terminal glucose units (ring B in Formulas 4-6) of the parent dextrin compound may undergo oxidative opening and amine functionalization according to the disclosure herein. Although Formulas 4-6 have shown a single oxidized glucose unit per dextrin molecule, it is to be appreciated that multiple oxidized and amine-functionalized glucose units may be present and arranged in any combination, with potential monomer positions for oxidation and amine functionalization being exemplified by those shown in Formulas 4-6. That is, particular amine-functionalized dextrin compounds of the present disclosure may feature an oxidized or non-oxidized A ring, any arrangement of oxidized or non-oxidized B rings (1-18 in total, or even up to 23 in total), and an oxidized or non-oxidized C ring, all linked together by α(1,4) glycosidic bonds.

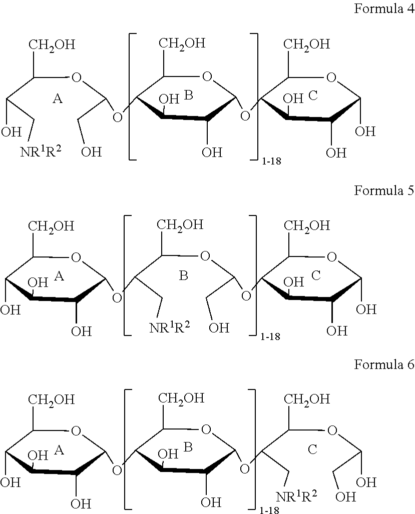

In Formulas 4-6, R¹ and R² may be the same or different and may be selected independently from H, alkyl, and aryl groups, with the proviso that R¹ and R² are not both H. According to more specific embodiments, R¹ and R² that are alkyl or aryl groups may be optionally substituted (e.g., bearing a heteroatom functionality, such as a second amine group), branched or linear, and/or cyclic or acyclic.

Amine-functionalized dextrin compounds suitable for use in the disclosure herein may feature oxidative opening upon about 5% to about 80% of the glucose monomer units. In more specific embodiments, about 10% to about 50% of the glucose monomer units in the amine-functionalized dextrin compound may be oxidatively opened. Any of the sites of oxidative opening may undergo amine functionalization in the disclosure herein, up to full amine functionalization of all of the sites of oxidative opening. Therefore, the percentage of glucose monomer units bearing amine functionalization may be about 80% or below or about 50% or below, including about 5% to about 80%, or about 10% to about 50%, or about 5% to about 30%.

Amine-functionalized dextrans suitable for use in the present disclosure may have structures corresponding to Formulas 7-9 below, in which one covalently bonded amine group is shown at each site of oxidative opening. It is to be appreciated that two covalently bonded amine groups may be present in some embodiments (structures not shown). Moreover, it is to be appreciated that not every site of oxidative opening necessarily becomes amine-functionalized and/or not every glucose monomer unit undergoes oxidative opening. Any combination of the terminal glucose units (rings A and C in Formulas 7-9) and non-terminal glucose units (ring B in Formulas 7-9) of the parent dextran may undergo oxidation and amine functionalization according to the disclosure herein. Moreover, although Formulas 7-9 have shown a single oxidized glucose unit per dextran polymer chain, it is be appreciated that multiple oxidized and amine-functionalized glucose units may be present and arranged in any combination, with potential monomer positions for oxidation being exemplified by those shown in Formulas 7-9. That is, particular amine-functionalized dextrans of the present disclosure may feature an oxidized or non-oxidized A ring, any arrangement and number of oxidized or non-oxidized B rings (about 5,000-300,000 glucose monomers in total), and an oxidized or non-oxidized C ring, all linked together by α(1,6) glycosidic bonds. As with the unfunctionalized dextran of Formula 3, the α(1,3)-linked glucose side chains are not depicted in Formulas 7-9 in the interest of clarity. Variables R¹ and R² are defined as above. The percentages of oxidative opening and amine functionalization may be similar to those described above for amine-functionalized maltodextrins.

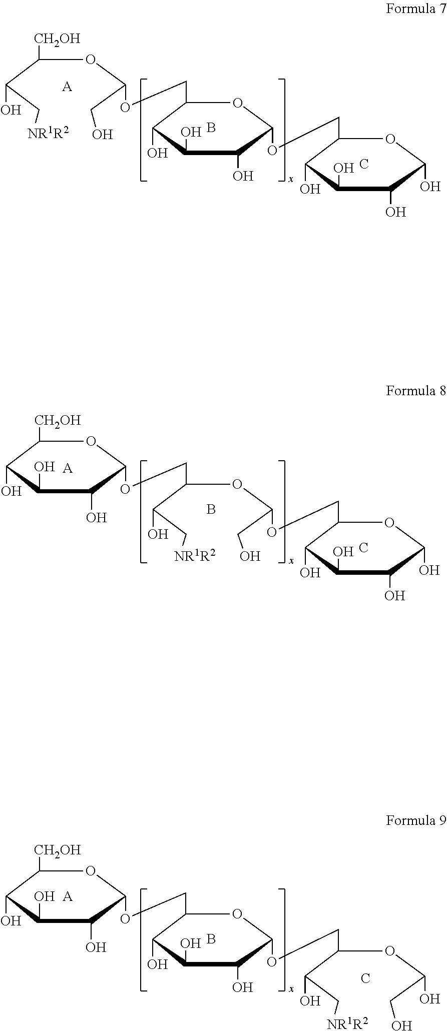

The aqueous compositions described above may be utilized in conjunction with dewatering a plurality of particulates in the disclosure herein. Depending on the aqueous composition utilized, the aqueous compositions may promote an increased aqueous fluid flow rate through the plurality of particulates and/or decrease the amount of residual moisture remaining in the plurality of particulates following dewatering, each as measured relative to water. In addition, clarity of the filtrate removed from the plurality of the particulates may be improved in some cases, which is believed to result from decreased production of fines during the dewatering process.

Accordingly, methods of the present disclosure may comprise: providing an aqueous composition comprising: an aqueous carrier fluid; a neutral surfactant or a reaction product form thereof; a reaction product of a first saccharide polymer and a fatty acid or a fatty ester, the first saccharide polymer comprising a dextran, a dextrin compound, or any combination thereof, and the reaction product of the first saccharide polymer and the fatty acid or the fatty ester and the reaction product form of the neutral surfactant, if present, being formed in the presence of a hydroxide base in the aqueous carrier fluid; and a zwitterionic surfactant; contacting the aqueous composition with a plurality of particulates; and removing the aqueous composition from the plurality of particulates. The aqueous composition may increase dewatering of the plurality of particulates relative to water, increase a flow rate through the plurality of particulates relative to water, or any combination thereof. In some embodiments, the aqueous composition contacted with the plurality of particulates may further comprise an amine-functionalized saccharide polymer, the amine-functionalized saccharide polymer being produced from a second saccharide polymer comprising a plurality of glucose units in which at least a portion of the glucose units have been oxidatively opened and functionalized with at least one amine group at a site of oxidative opening. Aqueous compositions in which the amine-functionalized saccharide polymer is present may be particularly advantageous in that the aqueous composition (filtrate) removed from the plurality of particulates may be of improved clarity and contain a low amount of residual fines. As such, when the amine-functionalized saccharide polymer is present during the dewatering process, the need to use clarifiers upon the filtrate following dewatering may be decreased or eliminated.

Contacting the aqueous composition with the plurality of particulates may comprise static mixing of the aqueous composition with the plurality of particulates, stirring the aqueous composition with the plurality of particulates, flowing the aqueous composition through the plurality of particulates (e.g., on a filter or screen), or any combination thereof. Other suitable contacting techniques may also be envisioned, such as gravity settling of the plurality of particulates within the aqueous compositions. Suitable contact times may range from about 10 seconds to about 24 hours, or about 30 seconds to about 10 minutes, or about 1 minute to about 5 minutes, or about 1 minute to about 30 minutes, or about 10 minutes to about 60 minutes. Contacting may be performed at any temperature between the freezing point and the boiling point of the aqueous composition. In some embodiments, contacting may be conducted at a temperature between room temperature (23° C.) and about 60° C., or between about room temperature and about 35° C.

Removing the aqueous composition from the plurality of particulates may comprise filtration, screening, decantation, centrifugation, hydrocyclone separation, gravity settling, or any combination thereof. Additional drying of the plurality of particulates may be conducted after a substantial majority of the aqueous composition has been removed from the plurality of particulates (e.g., after >95% by volume of the aqueous composition or >99% by volume of the aqueous composition has been removed). Additional drying may be conducted by heating, air drying, exposure to reduced pressure, or any combination thereof. In some examples, additional drying may take place in a rotary dryer or a fluidized bed dryer, examples of which will be familiar to persons having ordinary skill in the art. Additional sizing (size separation or size classification) of the plurality of particulates may take place during or after the additional drying process, if desired.

In non-limiting embodiments, the plurality of particulates undergoing at least partial dewatering in the disclosure herein may comprise a plurality of sand particulates. The sand particulates may be obtained from a sand mine, for instance, and after or during refining to a desired sand grade, the sand particulates may be contacted with the aqueous composition to undergo at least partial dewatering according to the disclosure herein. Other suitable particulate materials that may undergo at least partial dewatering in the disclosure herein include, for example, aggregate, slag, wood chips, iron oxide (e.g., for processing during an iron ore pelletization process), sludge materials from water treatment and chemical processes, drill cuttings, mineral processing residue, and the like.

The aqueous compositions disclosed herein may afford a lower level of residual moisture in the plurality of particulates compared to when the plurality of particulates are contacted with just water. Residual moisture content within the plurality of particulates after removing the aqueous composition therefrom may be about 20 wt. % or below, or about 19 wt. % or below, or about 18 wt. % or below based on total mass of the particulates and residual moisture. In some or other examples, the residual moisture content after contacting the plurality of particulates with the aqueous compositions may be decreased by about 5% or greater, or about 6% or greater, or about 7% or greater, or about 8% or greater, or about 9% or greater, or about 10% or greater, such as about 5% to about 10%, compared to the moisture content obtained when the plurality of particulates is contacted with just water. After the aqueous composition has been substantially removed from the plurality of particulates, the plurality of particulates may be further dried, as described in further detail above. After further drying, the residual moisture content may be about 5 wt. % or below, or about 1 wt. % or below, for example. Since the aqueous compositions may decrease the amount of residual moisture in the plurality of particulates compared to the amount otherwise present, the additional drying processes may be conducted more efficiently since there is less residual moisture to remove. Given that large quantities of particulates may undergo drying during a drying process, even small decreases in the amount of residual moisture may increase the efficiency of the drying process considerably. Thus, the aqueous compositions of the present disclosure may allow particulate washing and drying to be performed in a more efficient manner compared to water alone.

In some embodiments, dewatering of the plurality of particulates may take place in a subterranean formation, such as during a subterranean treatment operation, discussed subsequently. In other embodiments, dewatering of the plurality of particulates may take place in conjunction with a particulate production process or a particulate mining process, as discussed above.

### Subterranean Treatment Operations

The recovery of hydrocarbon resources, such as oil and gas, from subterranean formations is often performed in conjunction with introducing one or more subterranean treatment chemicals downhole. As used herein, the terms “treat,” “treatment,” “treating,” and grammatical equivalents thereof refer to any compound, fluid, or combination thereof that is introduced to a subterranean formation with the goal of achieving a desired function and/or for a desired purpose. A suitable treatment chemical or a treatment fluid may be selected based upon particular conditions present or anticipated to be present downhole.

The aqueous compositions of the present disclosure may be formulated as a subterranean treatment fluid. Treatment fluids may be used in a variety of subterranean treatment operations to facilitate or promote a desired outcome within the subterranean formation. As used herein, the term “treatment fluid” refers to any fluid used in a subterranean treatment operation in conjunction with achieving a desired function and/or for a desired purpose. Unless otherwise specified, use of the term “treatment fluid” does not imply any particular action by the treatment fluid or a component thereof. Illustrative treatment operations that may be facilitated through use of the reaction products, emulsifying compositions, and emulsified fluids of the present disclosure include, without limitation, drilling operations, stimulation operations, production operations, remediation operations, sand control operations, and the like, which may include, for example, fracturing operations, gravel packing operations, acidizing operations, descaling operations, consolidation operations, workover operations, cleanup operations, diversion operations, and the like.

As used herein, the term “drilling operation” refers to the process of forming a wellbore in a subterranean formation. As used herein, the term “drilling fluid” refers to a fluid used in drilling a wellbore.

As used herein, the term “stimulation operation” refers to an activity conducted within a wellbore to increase production therefrom. As used herein, the term “stimulation fluid” refers to a fluid used downhole during a stimulation activity to increase production of a hydrocarbon resource from the subterranean formation. In some instances, stimulation fluids may include a fracturing fluid or an acidizing fluid.

As used herein, the terms “clean-up operation” or “damage control operation” refer to any operation for removing extraneous material from a wellbore to increase production. As used herein, the terms “clean-up fluid” or “damage control fluid” refer to a fluid used for removing an unwanted material from a wellbore that otherwise blocks flow of a desired fluid therethrough. In one example, a clean-up fluid can be an acidified fluid for removing material formed by one or more perforation treatments. In another example, a clean-up fluid can be used to remove a filter cake upon the wellbore walls.

As used herein, the term “fracturing operation” refers to a high-pressure operation that creates or extends a plurality of flow channels within a subterranean formation. As used herein, the term “fracturing fluid” refers to a viscosified fluid used in conjunction with a fracturing operation. A plurality of proppant particulates may be present in a fracturing fluid to maintain the flow channels created or extended in the fracturing operation in an open state.

As used herein, the term “remediation operation” refers to any operation designed to maintain, increase, or restore a specific rate of production from a wellbore, which may include stimulation operations or clean-up operations. As used herein, the term “remediation fluid” refers to any fluid used in conjunction with a remediation operation.

As used herein, the term “acidizing operation” refers to any operation designed to remove an acid-soluble material from a wellbore, such as an acid-soluble material that comprises at least a portion of the subterranean formation. As used herein, the term “acidizing fluid” refers to a fluid used during an acidizing operation. Mineral acids, such as hydrochloric acid or hydrobromic acid, or organic acids may be present in compositions utilized for acidizing a carbonate formation, whereas hydrofluoric acid may be present in compositions utilized for acidizing a siliceous formation.

As used herein, the term “spotting fluid” refers to a fluid designed for localized treatment of a subterranean formation. In one example, a spotting fluid can include a lost circulation material for treatment of a specific section of the wellbore, such as to seal off fractures in the wellbore and prevent sag. In another example, a spotting fluid can include a water control material or material designed to free a stuck piece of drilling or extraction equipment.

As used herein, the term “completion fluid” refers to a fluid used during the completion phase of a wellbore, including cementing compositions and cementing fluids.

As used herein, the term “cementing fluid” refers to a fluid used during cementing operations within a wellbore.

The aqueous compositions of the present disclosure may also be used in conjunction with enhanced oil recovery (EOR) operations. When used in conjunction with EOR operations, the aqueous compositions of the present disclosure may change surface wetting within a subterranean formation to promote recovery of a hydrocarbon resource therefrom.

In any of the foregoing treatment operations, the treatment fluid may be foamed. Foamed fracturing fluids, for example, may be advantageous compared to viscosified treatment fluids for delivery of proppant particulates to a location in a wellbore. When foamed, treatment fluids may have a foam quality ranging from about 1% to about 99%.

Aqueous compositions of the present disclosure may be formulated into any of the treatment fluids discussed above. Treatment fluids of the present disclosure may feature a concentration of the aqueous compositions of about 0.1 gallons per thousand gallons (gpt) to about 10 gpt, or about 0.1 gpt to about 1 gpt, or about 0.2 gpt to about 0.5 gpt. These concentrations correspond to volume/volume percentages ranging from about 0.01% to about 1%, or from about 0.01% to about 0.1%, or from 0.02% to about 0.05%. The chosen concentration may vary depending upon the particular requirements for a given treatment operation and/or the specific subterranean conditions that are encountered downhole.

Treatment fluids of the present disclosure may optionally further comprise any number of additives that may be used in the oilfield services industry. Illustrative additives that may be present in a treatment fluid in combination with the reaction products of the present disclosure include, for example, surfactants, viscosifiers, gelling agents, gel stabilizers, anti-oxidants, polymer degradation prevention additives, relative permeability modifiers, scale inhibitors, corrosion inhibitors, chelating agents, foaming agents, defoaming agents, antifoaming agents, emulsifying agents, de-emulsifying agents, iron control agents, proppants or other particulates, particulate diverters, salts, acids, fluid loss control additives, gas, catalysts, other clay control agents, dispersants, flocculants, scavengers (e.g., H₂S scavengers, CO₂ scavengers or O₂ scavengers), lubricants, breakers, friction reducers, bridging agents, weighting agents, solubilizers, pH control agents (e.g., buffers), hydrate inhibitors, consolidating agents, bactericides, catalysts, the like, and any combination thereof. Suitable examples of these additives will be familiar to one having ordinary skill in the art.

Embodiments disclosed herein include:

A. Aqueous compositions to promote dewatering. The aqueous compositions comprise: an aqueous carrier fluid; a neutral surfactant or a reaction product form thereof; a reaction product of a first saccharide polymer and a fatty acid or a fatty ester, the first saccharide polymer comprising a dextran, a dextrin compound, or any combination thereof, and the reaction product of the first saccharide polymer and the fatty acid or the fatty ester and the reaction product form of the neutral surfactant, if present, being formed in the presence of a hydroxide base in the aqueous carrier fluid; a zwitterionic surfactant; and an amine-functionalized saccharide polymer, the amine-functionalized saccharide polymer being formed from a second saccharide polymer comprising a plurality of glucose units in which at least a portion of the glucose units have been oxidatively opened and functionalized with at least one amine group at a site of oxidative opening.

B. Methods for dewatering a plurality of particulates. The methods comprise: providing an aqueous composition comprising: an aqueous carrier fluid; a neutral surfactant or a reaction product form thereof; a reaction product of a first saccharide polymer and a fatty acid or a fatty ester, the first saccharide polymer comprising a dextran, a dextrin compound, or any combination thereof, and the reaction product of the first saccharide polymer and the fatty acid or the fatty ester and the reaction product form of the neutral surfactant, if present, being formed in the presence of a hydroxide base in the aqueous carrier fluid; and a zwitterionic surfactant; contacting the aqueous composition with a plurality of particulates; and removing the aqueous composition from the plurality of particulates to promote at least partial dewatering thereof.

B1. The method of B1, wherein the aqueous composition further comprises an amine-functionalized saccharide polymer, the amine-functionalized saccharide polymer being produced from a second saccharide polymer comprising a plurality of glucose units in which at least a portion of the glucose units have been oxidatively opened and functionalized with at least one amine group at a site of oxidative opening.

Embodiments A, B, and B1 may comprise one or more of the following additional embodiments in any combination.

Element 1: wherein the aqueous composition further comprises glycerol.

Element 2: wherein the reaction product of the first saccharide polymer is formed from a fatty ester, and at least a portion of the glycerol originates from the fatty ester.

Element 2A: wherein the reaction product of the first saccharide polymer is formed from a fatty ester, and the reaction product further comprises glycerol.

Element 3: wherein the fatty ester comprises a glycerol ester comprising up to three types of fatty acids, each having about 4 to about 30 carbon atoms.

Element 4: wherein the reaction product of the first saccharide polymer is formed from at least one fatty acid, the at least one fatty acid having about 4 to about 30 carbon atoms.

Element 5: wherein the reaction product of the first saccharide polymer and the fatty acid or the fatty ester is present in the aqueous carrier fluid at a concentration effective to lower a surface tension of the neutral surfactant.

Element 6: wherein the neutral surfactant or the reaction product form thereof is present in the aqueous carrier fluid at a sufficient concentration to solubilize the reaction product of the first saccharide polymer and the fatty acid or the fatty ester in the aqueous carrier fluid.

Element 7: wherein the first saccharide polymer and/or the second saccharide polymer comprises a dextrin compound, and the dextrin compound comprises a maltodextrin.

Element 8: wherein a molar ratio of fatty acid to saccharide polymer in the reaction product is about 0.2 or above on a basis of moles_{fatty acid or fatty acid in fatty ester}:moles_{glucose monomers in saccharide polymer}.

Element 9: wherein the reaction product of the first saccharide polymer comprises a fatty ester saccharide polymer reaction product.

Element 10: wherein the neutral surfactant comprises a fatty acid alkanolamide.

Element 11: wherein the fatty acid alkanolamide comprises a compound selected from the group consisting of cocamide diethanolamine, cocamide monoethanolamine, cocamide diisopropanolamine, palmitic amide diethanolamine, palmitic amide monoethanolamine, palmitic amide diisopropanolamine, and any combination thereof.

Element 12: wherein the zwitterionic surfactant comprises at least one betaine.

Element 13: wherein the amine-functionalized saccharide polymer comprises an amine-functionalized dextrin compound comprising 2 to about 20 glucose units linked together with α(1,4) glycosidic bonds, an amine-functionalized dextran comprising a plurality of glucose units linked together with α(1,6) glycosidic bonds, or any combination thereof.

Element 14: wherein the amine-functionalized saccharide polymer bears a secondary amine or a tertiary amine directly covalently bound to one or more sites of oxidative opening.

Element 15: wherein the amine-functionalized saccharide polymer bears a primary alcohol and the secondary amine or the tertiary amine at one or more sites of oxidative opening.

Element 16: wherein dewatering takes place in a subterranean formation.

Element 17: wherein dewatering takes place in conjunction with a particulate production or a particulate mining process.

Element 18: wherein removing the aqueous composition from the plurality of particulates comprises filtration, screening, decantation, centrifugation, hydrocyclone separation, gravity settling, or any combination thereof.

Element 19: wherein the plurality of particulates comprises a plurality of sand particulates.

By way of non-limiting example, exemplary combinations applicable to A, B, and B1 include, but are not limited, to: 2, 2A, and/or 3, and 4 and/or 6; 2, 2A, and/or 3, and 7; 2, 2A, and/or 3, and 9; 2, 2A, and/or 3, and 10; 2, 2A, and/or 3, and 10 and 11; 2, 2A, and/or 3, and 10 and 12; 2, 2A, and/or 3, and 12; 2, 2A, and/or 3, and 10-12; 2, 2A, and/or 3, and 13; 2, 2A, and/or 3, and 16 or 17; 2, 2A, and/or 3, and 18; 2, 2A, and/or 3, and 19; 2, 2A, and/or 3, and 17 and 18; 2, 2A, and/or 3, and 17 and 19; 2, 2A, and/or 3, and 17-19; 4, and 5 and/or 6; 4 and 7; 4 and 9; 4 and 10; 4, and 10 and 11; 4, and 10 and 12; 4 and 12; 4 and 10-12; 4 and 13; 4, and 16 or 17; 4 and 18; 4 and 19; 4, and 17 and 18; 4, and 17 and 19; 4, and 17-19; 7 and 8; 7 and 9; 7 and 10; 7, and 10 and 11; 7, and 10 and 12; 7 and 12; 7 and 10-12; 7 and 13; 7, and 16 or 17; 7 and 18; 7 and 19; 7, and 17 and 18; 7, and 17 and 19; 7, and 17-19; 9 and 10; 9, and 10 and 11; 9, and 10 and 12; 9 and 12; 9 and 10-12; 9 and 13; 9, and 16 or 17; 9 and 18; 9 and 19; 9, and 17 and 18; 9, and 17 and 19; 9, and 17-19; 12 and 13; 12 and 14; 12, 14, and 15; 12 and 15; 12, and 16 or 17; 12 and 18; 12 and 19; 12, and 17 and 18; 12, and 17 and 19; 12, and 17-19; 13 and 14; 13-15; 13 and 15; 13, and 16 or 17; 13 and 18; 13 and 19; 13, and 17 and 18; 13, and 17 and 19; 13, and 17-19; 17 and 18; 17 and 19; and 17-19.

The present disclosure is further directed to the following non-limiting clauses:

Clause 1. An aqueous composition comprising:
an aqueous carrier fluid;
a neutral surfactant or a reaction product form thereof;
a reaction product of a first saccharide polymer and a fatty acid or a fatty ester, the first saccharide polymer comprising a dextran, a dextrin compound, or any combination thereof, and the reaction product of the first saccharide polymer and the fatty acid or the fatty ester and the reaction product form of the neutral surfactant, if present, being formed in the presence of a hydroxide base in the aqueous carrier fluid;
a zwitterionic surfactant; and
an amine-functionalized saccharide polymer, the amine-functionalized saccharide polymer being formed from a second saccharide polymer comprising a plurality of glucose units in which at least a portion of the glucose units have been oxidatively opened and functionalized with at least one amine group at a site of oxidative opening.

Clause 2. The aqueous composition of clause 1, further comprising:
glycerol.

Clause 3. The aqueous composition of clause 2, wherein the reaction product of the first saccharide polymer is formed from a fatty ester, and at least a portion of the glycerol originates from the fatty ester.

Clause 4. The aqueous composition of any one of clauses 1-3, wherein the fatty ester comprises a glycerol ester comprising up to three types of fatty acids, each having about 4 to about 30 carbon atoms.

Clause 5. The aqueous composition of clause 1, wherein the reaction product of the first saccharide polymer is formed from at least one fatty acid, the at least one fatty acid having about 4 to about 30 carbon atoms.

Clause 6. The aqueous composition of clause 1, wherein the reaction product of the first saccharide polymer and the fatty acid or the fatty ester is present in the aqueous carrier fluid at a concentration effective to lower a surface tension of the neutral surfactant.

Clause 7. The aqueous composition of clause 1 or clause 6, wherein the neutral surfactant or the reaction product form thereof is present in the aqueous carrier fluid at a concentration effective to solubilize the reaction product of the first saccharide polymer and the fatty acid or the fatty ester in the aqueous carrier fluid.

Clause 8. The aqueous composition of clause 1, wherein the first saccharide polymer and/or the second saccharide polymer comprises a dextrin compound, and the dextrin compound comprises a maltodextrin.

Clause 9. The aqueous composition of clause 1, wherein the first saccharide polymer comprises a dextrin compound, and the dextrin compound comprises a maltodextrin.

Clause 10. The aqueous composition of clause 1, wherein the second saccharide polymer comprises a dextrin compound, and the dextrin compound comprises a maltodextrin.

Clause 11. The aqueous composition of any one of clauses 1 or 8-10, wherein a molar ratio of fatty acid to first saccharide polymer in the reaction product is about 0.2 or above on a basis of moles_{fatty acid or fatty acid in fatty ester}:moles_{glucose monomers in first saccharide polymer}.

Clause 12. The aqueous composition of any one of clauses 1 or 8-10, wherein a molar ratio of fatty acid to first saccharide polymer in the reaction product is about 0.2 to about 0.9 on a basis of moles_{fatty acid or fatty acid in fatty ester}:moles_{glucose monomers in first saccharide polymer}.

Clause 13. The aqueous composition of any one of clauses 1 or 8-10, wherein the reaction product of the first saccharide polymer comprises a fatty ester saccharide polymer reaction product.

Clause 14. The aqueous composition of any one of clauses 1 or 8-10, wherein the zwitterionic surfactant comprises at least one betaine.

Clause 15. The aqueous composition of any one of clauses 1 or 8-10, wherein the neutral surfactant comprises a fatty acid alkanolamide.

Clause 16. The aqueous composition of clause 15, wherein the fatty acid alkanolamide comprises a compound selected from the group consisting of cocamide diethanolamine, cocamide monoethanolamine, cocamide diisopropanolamine, palmitic amide palmitic diethanolamine, amide monoethanolamine, palmitic amide diisopropanolamine, and any combination thereof.

Clause 17. The aqueous composition of clause 1, wherein the amine-functionalized saccharide polymer comprises an amine-functionalized dextrin compound comprising 2 to about 20 glucose units linked together with α(1,4) glycosidic bonds, an amine-functionalized dextran comprising a plurality of glucose units linked together with α(1,6) glycosidic bonds, or any combination thereof.

Clause 18. The aqueous composition of clause 1 or clause 17, wherein the amine-functionalized saccharide polymer bears a secondary amine or a tertiary amine directly covalently bound to one or more sites of oxidative opening.

Clause 19. The aqueous composition of clause 18, wherein the amine-functionalized saccharide polymer bears a primary alcohol and the secondary amine or the tertiary amine at one or more sites of oxidative opening.

Clause 20. A method comprising:
providing an aqueous composition comprising:
   an aqueous carrier fluid;
   a neutral surfactant or a reaction product form thereof;
   a reaction product of a first saccharide polymer and a fatty acid or a fatty ester, the first saccharide polymer comprising a dextran, a dextrin compound, or any combination thereof, and the reaction product of the first saccharide polymer and the fatty acid or the fatty ester and the reaction product form of the neutral surfactant, if present, being formed in the presence of a hydroxide base in the aqueous carrier fluid; and
   a zwitterionic surfactant;
contacting the aqueous composition with a plurality of particulates; and
removing the aqueous composition from the plurality of particulates;
   wherein the aqueous composition increases dewatering of the plurality of particulates relative to water, increases a flow rate through the plurality of particulates relative to water, or any combination thereof.

Clause 21. The method of clause 20, wherein the first saccharide polymer comprises a maltodextrin.

Clause 22. The method of clause 20, wherein the aqueous composition further comprises an amine-functionalized saccharide polymer, the amine-functionalized saccharide polymer being produced from a second saccharide polymer comprising a plurality of glucose units in which at least a portion of the glucose units have been oxidatively opened and functionalized with at least one amine group at a site of oxidative opening.

Clause 23. The method of clause 22, wherein the first saccharide polymer and/or the second saccharide polymer comprises a dextrin compound, and the dextrin compound comprises a maltodextrin.

Clause 24. The method of clause 22, wherein the first saccharide polymer comprises a dextrin compound, and the dextrin compound comprises maltodextrin.

Clause 25. The method of clause 22, wherein the second saccharide polymer comprises a dextrin compound, and the dextrin compound comprises a maltodextrin.

Clause 26. The method of clause 22, wherein the amine-functionalized saccharide polymer comprises an amine-functionalized dextrin compound comprising 2 to about 20 glucose units linked together with α(1,4) glycosidic bonds, an amine-functionalized dextran comprising a plurality of glucose units linked together with α(1,6) glycosidic bonds, or any combination thereof.

Clause 27. The method of any one of clauses 22-26, wherein the amine-functionalized saccharide polymer bears a secondary amine or a tertiary amine directly covalently bound to one or more sites of oxidative opening.

Clause 28. The method of clause 27, wherein the amine-functionalized saccharide polymer bears a primary alcohol and the secondary amine or the tertiary amine at one or more sites of oxidative opening.

Clause 29. The method of any one of clauses 20-26, wherein dewatering takes place in a subterranean formation.

Clause 30. The method of any one of clauses 20-26, wherein dewatering takes place in conjunction with a particulate production process or a particulate mining process.

Clause 31. The method of any one of clauses 20-26, wherein removing the aqueous composition from the plurality of particulates comprises filtration, screening, decantation, centrifugation, hydrocyclone separation, gravity settling, or any combination thereof.

Clause 32. The method of any one of clauses 20-26, wherein the plurality of particulates comprises a plurality of sand particulates.

Clause 33. The method of any one of clauses 20-26, wherein the reaction product of the first saccharide polymer is formed from a fatty ester, and the reaction product further comprises glycerol.

Clause 34. The method of clause 33, wherein the fatty ester comprises a glycerol ester comprising up to three types of fatty acids, each having about 4 to about 30 carbon atoms.

Clause 35. The method of any one of clauses 20-26, wherein the reaction product of the first saccharide polymer is formed from at least one fatty acid, the at least one fatty acid having about 4 to about 30 carbon atoms.

Clause 36. The method of any one of clauses 20-26, wherein a molar ratio of fatty acid to first saccharide polymer in the reaction product is about 0.2 or above on a basis of moles_{fatty acid or fatty acid in fatty ester}:moles_{glucose monomers in first saccharide polymer}.

Clause 37. The method of any one of clauses 20-26, wherein a molar ratio of fatty acid to first saccharide polymer in the reaction product is about 0.2 to about 0.9 on a basis of moles_{fatty acid or fatty acid in fatty ester}:moles_{glucose monomers in first saccharide polymer}.

Clause 38. The method of any one of clauses 20-26, wherein the neutral surfactant comprises a fatty acid alkanolamide.

Clause 39. The method of clause 38, wherein the fatty acid alkanolamide comprises a compound selected from the group consisting of cocamide diethanolamine, cocamide monoethanolamine, cocamide diisopropanolamine, palmitic amide diethanolamine, palmitic amide monoethanolamine, palmitic amide diisopropanolamine, and any combination thereof.

Clause 40. The method of any one of clauses 20-26, wherein the zwitterionic surfactant comprises at least one betaine.

To facilitate a better understanding of the disclosure herein, the following examples of various representative embodiments are given. In no way should the following examples be read to limit, or to define, the scope of the invention.

### EXAMPLES

Example 1: Representative Procedure for Preparation of Maltodextrin Reactions Products Using a Glycerol Ester. 25.00 g fatty acid alkanolamide surfactant and 10.00 g KOH (45% active solution) were combined in water. The reaction mixture was mechanically stirred and heated to 65° C. Thereafter, soybean oil and 150.0 g maltodextrin (MALTRIN M100, Grain Processing Corporation, Muscatine, Iowa; DE=9.0-12.0) as a 30% active solution were added to the reaction mixture. The amount of soybean oil was selected to provide a HLB of either 12 or 16 upon formation of a reaction product. The amount of water was selected to provide a surfactant concentration of 5 wt. %, a fatty ester (oil) concentration of 2.5 wt. %, and a maltodextrin concentration of 10 wt. %, based on all reaction components. Once the maltodextrin dissolved, heating was discontinued and stirring was conducted until the reaction mixture reached room temperature. The resulting aqueous phase containing the reaction products was used without further processing for the additional formulations and testing below. Dextran reaction products may be formed using a similar procedure. Other fatty esters and alkanolamide surfactants may be used similarly.

Example 2: Representative Procedure for Preparation of Maltodextrin Reaction Products Using Free Fatty Acids. 25.00 g fatty acid alkanolamide surfactant and 10.00 g KOH (45% active solution) were combined in water. The reaction mixture was mechanically stirred and heated to 65° C. Thereafter, a fatty acid mixture containing saturated fatty acids, including lauric acid and myristic acid as main components, and 150.0 g maltodextrin (MALTRIN M100, Grain Processing Corporation, Muscatine, Iowa; DE=9.0-12.0) as a 30% active solution were added to the reaction mixture. The amount of the fatty acid mixture was selected to provide a HLB of either 12 or 16. The amount of water was selected to provide a surfactant concentration of 5 wt. %, a fatty acid concentration of 2.5 wt. %, and a maltodextrin concentration of 10 wt. %, based on all reaction components. Once the maltodextrin dissolved, heating was discontinued and stirring was conducted until the reaction mixture reached room temperature. The resulting aqueous phase containing the reaction products was used without further processing for the additional formulations and testing below. Dextran reaction products may be formed using a similar procedure. Other fatty esters and alkanolamide surfactants may be used similarly.

Amine-Functionalized Maltodextrin. Amine-functionalized maltodextrin was prepared as described in U.S. Pat. No. 11,130,905. In brief, an aqueous maltodextrin solution was treated with sodium periodate at room temperature and used without further purification for reaction with various amines. The product was 15% active by weight.

Flow Performance of Aqueous Compositions. Aqueous compositions were formulated as in Table 1. The aqueous compositions in Table 1 were diluted to a concentration of 2 gpt (gallons per 1000 gallons) before conducting the flow performance tests described further below.

TABLE 1

| Entry | Composition |
|---|---|
| 1 | Tap Water Control |
| 2 | 75 Wt. % Amine-Functionalized Maltodextrin |
| | (15% active by weight) |
| 3 | Example 2 (10 Wt. % Maltodextrin Reaction |
| | Product) |
| 4 | 15 Wt. % Cocoamidopropyl Betaine |
| 5 | 75 Wt. % Amine-Functionalized Maltodextrin |
| | (15% active by weight)/15 Wt. % |
| | Cocoamidopropyl Betaine |
| 6 | 75 Wt. % Amine-Functionalized Maltodextin |
| | (15% active by weight)/Example 2 (10 Wt. |
| | % Maltodextrin Reaction Product) |
| 7 | Example 2 (10 Wt. % Maltodextrin Reaction |
| | Product)/15 Wt. % Cocoamidopropyl Betaine |
| 8 | 75 Wt. % Amine-Functionalized Maltodextin |
| | (15% active by weight)/Example 2 (10 Wt. |
| | % Maltodextrin Reaction Product)/15 Wt. % |
| | Cocoamidopropyl Betaine |

After dilution to 2 gpt, the aqueous compositions in Table 1 were contacted with sand particulates to evaluate flow performance. Contact with the sand particulates was performed as follows: 400 g of dry sand was placed in a Buchner funnel containing a 25 μm filter to create a sand pack. The sand particulates were used as received and not otherwise preconditioned. 250 ml of the diluted aqueous composition was poured onto the sand pack and drained through the Buchner funnel by gravity (no vacuum was applied). A stopwatch was started when the aqueous composition was poured onto the sand pack, and the volume of aqueous fluid was recorded as a function of time by collecting the drained aqueous composition in a graduated cylinder. The time was recorded each time 20 mL of filtrate was collected, and the total volume of filtrate collected at 5 minutes was also recorded. The volume and time at which the sand pack was no longer submerged in the aqueous composition were also recorded.

After 5 minutes, the resulting wet sand filter cake was placed on a tared sheet of aluminum foil and weighed. The wet sand filter cake was then heated in an oven at 105° C. until a consistent mass was reached (2-3 hr). The mass of the resulting dry filter cake was compared to the wet filter cake mass to determine the residual moisture content of the wet sand filter cake following contact with the aqueous composition.

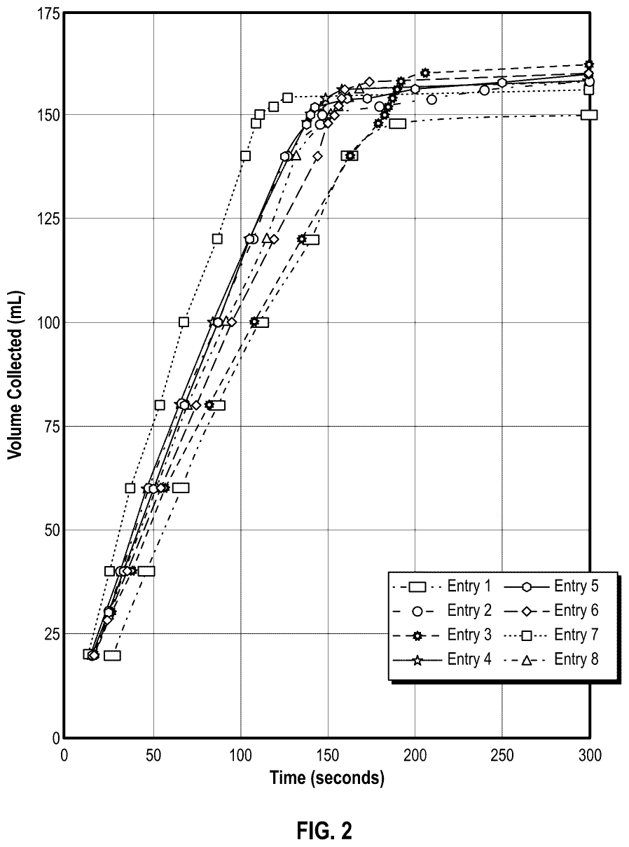

FIG. 2 is a graph of flow performance of various aqueous compositions through sand particulates (volume of aqueous fluid collected versus time). As shown, the aqueous composition of Entry 7 (maltodextrin reaction product/neutral surfactant/cocamidopropyl betaine) afforded significantly faster flow performance than did the other samples, as demonstrated by left-shifting of the curve relative to the other samples. The left-shifting of the curve is indicative of a greater volume of aqueous composition collected over a shorter amount of time. All of the experimental samples afforded better flow performance than did a tap water control (Entry 1).

Residual moisture contents of the sand particulates following each treatment from above are shown in Table 2.

TABLE 2

| | Residual Moisture |
|---|---|
| Entry | Content (Wt. %) |
| 1 | 19.98 |
| 2 | 19.05 |
| 3 | 18.28 |
| 4 | 17.50 |
| 5 | 17.84 |
| 6 | 19.50 |
| 7 | 18.85 |
| 8 | 18.29 |

As shown in Table 2, the aqueous composition containing the betaine surfactant alone (Entry 4) afforded the lowest residual moisture content. Among the aqueous compositions containing an amine-functionalized maltodextrin and/or the maltodextrin reaction product of Example 2, the aqueous compositions of Entries 5 and 8 afforded particularly low residual moisture contents. All of the residual moisture contents were below that afforded by the tap water control (Entry 1). The filtrate clarity was considerably better for the aqueous composition of Entry 8 compared to that of Entry 5 or other aqueous compositions tested above.

Unless otherwise indicated, all numbers expressing quantities and the like in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating various features are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While various systems, compositions, tools and methods are described herein in terms of “comprising” various components or steps, the systems, compositions, tools and methods can also “consist essentially of” or “consist of” the various components and steps.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Therefore, the disclosed systems, compositions, tools and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems, compositions, tools and methods illustratively disclosed herein may suitably be practiced in the absence of any element that is not specifically disclosed herein and/or any optional element disclosed herein. While systems, compositions, tools and methods are described in terms of “comprising,” “containing,” or “including” various components or steps, the systems, tools and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

1. An aqueous composition comprising:
an aqueous carrier fluid;
a neutral surfactant or a reaction product form thereof;
a reaction product of a first saccharide polymer and a fatty acid or a fatty ester, the first saccharide polymer comprising a dextran, a dextrin compound, or any combination thereof, and the reaction product of the first saccharide polymer and the fatty acid or the fatty ester and the reaction product form of the neutral surfactant, if present, being formed in the presence of a hydroxide base in the aqueous carrier fluid;
a zwitterionic surfactant; and
an amine-functionalized saccharide polymer, the amine-functionalized saccharide polymer being formed from a second saccharide polymer comprising a plurality of glucose units in which at least a portion of the glucose units have been oxidatively opened and functionalized with at least one amine group at a site of oxidative opening.

2. The aqueous composition of claim 1, further comprising:
glycerol.

3. (canceled)

4. (canceled)

5. (canceled)

6. (canceled)

7. The aqueous composition of claim 1, wherein the neutral surfactant or the reaction product form thereof is present in the aqueous carrier fluid at a concentration effective to solubilize the reaction product of the first saccharide polymer and the fatty acid or the fatty ester in the aqueous carrier fluid.

8. The aqueous composition of claim 1, wherein the first saccharide polymer and/or the second saccharide polymer comprises a dextrin compound, and the dextrin compound comprises a maltodextrin.

9. (canceled)

10. (canceled)

11. (canceled)

12. The aqueous composition of claim 1, wherein a molar ratio of fatty acid to first saccharide polymer in the reaction product is about 0.2 to about 0.9 on a basis of moles_{fatty acid or fatty acid in fatty ester}:moles_{glucose monomers in first saccharide polymer}.

13. The aqueous composition of claim 1, wherein the reaction product of the first saccharide polymer comprises a fatty ester saccharide polymer reaction product.

14. The aqueous composition of claim 1, wherein the zwitterionic surfactant comprises at least one betaine.

15. The aqueous composition of claim 1, wherein the neutral surfactant comprises a fatty acid alkanolamide.

16. (canceled)

17. The aqueous composition of claim 1, wherein the amine-functionalized saccharide polymer comprises an amine-functionalized dextrin compound comprising 2 to about 20 glucose units linked together with α(1,4) glycosidic bonds, an amine-functionalized dextran comprising a plurality of glucose units linked together with α(1,6) glycosidic bonds, or any combination thereof.

18. The aqueous composition of claim 1, wherein the amine-functionalized saccharide polymer bears a secondary amine or a tertiary amine directly covalently bound to one or more sites of oxidative opening.

19. (canceled)

20. A method comprising:
providing an aqueous composition comprising:
an aqueous carrier fluid;
a neutral surfactant or a reaction product form thereof;
a reaction product of a first saccharide polymer and a fatty acid or a fatty ester, the first saccharide polymer comprising a dextran, a dextrin compound, or any combination thereof, and the reaction product of the first saccharide polymer and the fatty acid or the fatty ester and the reaction product form of the neutral surfactant, if present, being formed in the presence of a hydroxide base in the aqueous carrier fluid; and
a zwitterionic surfactant;
contacting the aqueous composition with a plurality of particulates; and
removing the aqueous composition from the plurality of particulates;
wherein the aqueous composition increases dewatering of the plurality of particulates relative to water, increases a flow rate through the plurality of particulates relative to water, or any combination thereof.

21. The method of claim 20, wherein the first saccharide polymer comprises a maltodextrin.

22. The method of claim 20, wherein the aqueous composition further comprises an amine-functionalized saccharide polymer, the amine-functionalized saccharide polymer being produced from a second saccharide polymer comprising a plurality of glucose units in which at least a portion of the glucose units have been oxidatively opened and functionalized with at least one amine group at a site of oxidative opening.

23. (canceled)

24. (canceled)

25. (canceled)

26. The method of claim 22, wherein the amine-functionalized saccharide polymer comprises an amine-functionalized dextrin compound comprising 2 to about 20 glucose units linked together with α(1,4) glycosidic bonds, an amine-functionalized dextran comprising a plurality of glucose units linked together with α(1,6) glycosidic bonds, or any combination thereof.

27. The method of claim 22, wherein the amine-functionalized saccharide polymer bears a secondary amine or a tertiary amine directly covalently bound to one or more sites of oxidative opening.

28. (canceled)

29. The method of claim 20, wherein dewatering takes place in a subterranean formation.

30. The method of claim 20, wherein dewatering takes place in conjunction with a particulate production process or a particulate mining process.

31. The method of claim 20, wherein removing the aqueous composition from the plurality of particulates comprises filtration, screening, decantation, centrifugation, hydrocyclone separation, gravity settling, or any combination thereof.

32. The method of claim 20, wherein the plurality of particulates comprises a plurality of sand particulates.

33. The method of claim 20, wherein the reaction product of the first saccharide polymer is formed from a fatty ester, and the reaction product further comprises glycerol.

34. (canceled)

35. (canceled)

36. (canceled)

37. The method of claim 20, wherein a molar ratio of fatty acid to first saccharide polymer in the reaction product is about 0.2 to about 0.9 on a basis of moles_{fatty acid or fatty acid in fatty ester}:moles_{glucose monomers in first saccharide polymer}.

38. The method of claim 20, wherein the neutral surfactant comprises a fatty acid alkanolamide.

39. (canceled)

40. The method of claim 20, wherein the zwitterionic surfactant comprises at least one betaine.
